(19) United States
(12) Patent Application Publication
(10) Pub. No.: US 2022/0222758 A1
(43) Pub. Date: Jul. 14, 2022

(54) SYSTEMS AND METHODS FOR EVALUATING AND APPRAISING REAL AND PERSONAL PROPERTY

(71) Applicant: Thomas J. BECKMAN, Washington, DC (US)

(72) Inventor: Thomas J. BECKMAN, Washington, DC (US)

(21) Appl. No.: 17/146,405

(22) Filed: Jan. 11, 2021

(51) Int. Cl. G06Q 50/16; G06Q 50/18

(52) U.S. Cl. CPC G06Q 50/16; G06Q 50/184

(57) ABSTRACT

The present disclosure relates to systems and methods of assessing and valuating property, including, for example, real property, otherwise known as real estate; personal property; intellectual property; and financial instruments. The described systems and methods create a set of relevant comparable properties (or “comps”) via selection and elimination of comps based on specific criteria, including, in the case of valuating real estate, criteria such as location proximity, property type, time proximity, and transaction type. Next, a set of relevant features (which are present in both the subject property to be assessed and valuated as well as one or more of the relevant comps) is also selected, scored, compared, and adjusted. After determining the difference in feature scores between subject and each comp, weighing, valuing, and monetizing of the set of relevant feature adjustments follows, which is then utilized to generate a valuation for the subject property.

### FIELD OF THE DISCLOSURE

This disclosure relates generally to the evaluation and/or appraisal of various property, including real property, personal property, financial instruments, and the like.

### BACKGROUND

Existing systems and methods for valuating property, including both real property and personal property, for retail sale suffer from a variety of issues, including the failure to select comparable other properties that are on the market or recently sold similar to the specific subject property for sale or under consideration.

Additionally, these existing systems and methods can be error-prone, involving subjective selection of relevant property features, inaccurate calculations/algorithms, manual scoring of these features, and unreliable estimates of property valuation, as well as other biases, errors, deficiencies, and omissions.

Needs therefore exist for improved systems and methods for valuating various kinds of property, including, but not limited to, real property and personal property.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed automated systems and methods for assessing and valuating property may include one or more of the features described herein.

Embodiments of the present disclosure include systems and methods for assessing and valuating property, including real property (also referred to in this disclosure as “real estate,” with the terms “real property” and “real estate” used interchangeably), which refers to, as non-limiting examples, residential property, commercial property, industrial property, rental of the aforementioned properties, and raw land; personal property, including, but not limited to, personal possessions and items, such as, for example, vehicles, fine art, decorative art, musical instruments, and other saleable objects; intellectual property, including but not limited to, patents, copyright, trademarks, systems and methods, human capital, software programs, databases, and digital content; and financial instruments, such as, for instance, publicly-offered securities, initial public offerings (IPOs), secondary offerings, and mergers and acquisitions.

In at least one embodiment of an automated method for valuating a predetermined piece of real property, referred to herein as a “subject property” or “subject.” Both of these terms, as used herein, therefore refer to a piece of real estate that is predetermined and/or preselected to be of interest to a user. In addition, comparable properties, referred to herein as “comps,” are properties similar to the subject that are compared to the subject and adjusted for differences in features to achieve the assessment and valuation of the subject property.

One or more embodiments described herein relate to systems and methods for assessing and valuating residential real estate. These systems and methods comprise multiple improvements upon the standard Sales Comparison Approach (SCA), which is the accepted best practice in appraising real estate properties. One of skill in the art will recognize that the SCA is a three-step process. First, an individual must identify, filter, and select the most similar and the most relevant comparable properties to the subject property. Second, one must evaluate both the subject property and the comps to determine the set of features to be compared, score these features for each property, and compare these feature scores and adjust for differences between these features. Third, and finally, one must value the feature differences for each comp, and arrive at the best estimate of market value for the subject property.

In some embodiments, such as real estate, where the universe of potential comps is large, a comp selection process is employed to select a small set of the most similar and relevant comps to the subject property.

It should be appreciated that an important step in any valuation process, including the SCA, is to select the most similar set of comps as possible to compare with the subject property, since such comps help generate a reliable estimate of market value for the subject property. In other words, comparing dissimilar comps generally leads to less accurate valuations.

It should further be appreciated that the present disclosure, in its various embodiments, provides for the selection of a variety of comparison properties. “Comparison properties” are those that are selected for use in valuating a subject property. In preferred examples, the comparison properties are comparable properties (“comp” or “comps”) similar to the subject property to be valued and sold. Such selection includes, for example, the creation of a set of potential comps, the filtering of these potential comps to find adequate comps to the subject property, and the selection of these comps. Additional steps may also be present, such as, for instance, the electronic display and/or saving to a database or computer memory of one or more comps.

In at least one embodiment, the systems and methods described herein allow an individual to provide better, and more accurate, valuations in part by selecting better comps. Embodiments of the systems and methods better ensure the generation of relevant comps, including comps that have features in common with the subject property. Embodiments of the systems and methods also better eliminate comps that are too dissimilar from the subject property, thus allowing for a more accurate evaluation of the similarity of relevant comps with the subject property. Finally, embodiments of the systems and methods select and rank the most similar comps for a detailed comparison with the subject property.

In particular, selecting a set of comparison properties, referred to herein as “comps,” from the universe of comparison properties is accomplished by selecting a plurality of search and similarity parameters, in order to select a set of the most similar comps to the subject from a universe or pool of potential comps. Accordingly, the following non-exhaustive list of parameters may be used when the subject property is, for example, residential real estate: Property Type, Transaction Type, Location Proximity, Time Proximity, GLA, and Modified Sale Price.

It should further be appreciated that the present disclosure in its various embodiments performs one or more of the aforementioned steps in an automated manner, thereby reducing the risk of human error, comp selection bias, comp selection mistakes, errors involving the selection of appropriate or relevant features, miscalculations of feature values, inadequate weighting of comp and feature calculations, and the like. In sample valuation tests, the embodiment of the present disclosure for residential real estate resulted in a difference of only 1.1% between the predicted sales price and the actual sales price.

The systems and methods in the present disclosure provide a number of innovations to improve the accuracy of assessments and appraisals over existing Automated Valuation Models (AVMs) and licensed appraisers. These improvements include, but are not limited to:
a) Creating a framework to transparently organize and display the valuation of complex property embodiments with varied types of properties, features, parameters, and calculations/algorithms;
b) Creating a framework with sufficient capability and flexibility to represent various embodiments that may have differing comp selection methods and parameters; differing types and plurality of properties; differing types and plurality of features; differing types and plurality of feature scoring algorithms; differing types and plurality of feature adjustment fractions; and differing final comp weighting valuation formulae. See, for instance, Examples 1-3 herein relating to residential real estate and fine art;
c) Considering many aspects of a subject property to be assessed for possible adjustment, and, for the embodiment of residential real estate, as an example, adjustment of 31 or more features for the subject and related set of selected comps;
d) Converting feature entries of varying data types including, but not limited to, numerical, categorical, textual (unstructured and semi-structured data), and special, into numerical feature scores by means of feature scoring formulae;
e) Converting feature adjustment scores into feature adjustment values by means of feature adjustment fractions and feature adjustment value formulae that weigh, scale, and monetize feature scores into feature values in USD;
f) Developing and employing a comp selection process for some embodiments where the universe of potential comps is large, such as real estate, in order to filter out dissimilar comps and to select a small set of the most similar and relevant comps to the subject property for subsequent valuation;
g) Selecting potential comps by only considering the same property type, and arms-length market transaction type;
h) Selecting better comps for comparison to the subject by calculating the most similar scores based on Gross Living Area (GLA) and modified sale price using an imputed subject sale price;
i) Applying one of several feature scoring formulae to corresponding feature types including, but not limited to: feature classification, attribute summation, Likert scale ranking, exponential decay, text analysis, raw score entry, updated market trends, and current market conditions.
j) Applying exponential decay formulas to score some features involving area or time duration;
k) Applying Likert scale metrics to score and rank some features involving subjective judgments;
l) Applying text analysis and text mining techniques to properties containing relevant text to uncover and score some feature adjustments described in text;
m) Applying summation of aspects/attributes to score some features involving multiple attributes;
n) Classifying and converting categorical symbolic feature entries into numeric scores based on relative favorability according to current buyer/market preferences;
o) Making adjustments to comps based on difference in market trends in sale price between contract date and appraisal date;
p) Making adjustments to comp sale price based on changing and current market conditions such as: average days on market (DOM), average listing price vs. contract price, sale price trends, seasonality, demand (sales for the last month, year over year); inventory (supply of houses listed for sale (in days) based on demand); regional/local average housing sale prices (year over year); percent of real estate owned by banks (REO); percent of short sales; and percent of rentals;
q) Applying the comp modified sale price to each feature to properly scale and monetize nearly all feature adjustments (by unit value). This ensures the proper scaling of adjustments based on widely differing neighborhood property values, as opposed to the fixed dollar adjustment amounts used by most appraisers.
r) Applying a feature adjustment fraction (FAF) to take a dimensionless numeric feature adjustment score as input and convert it to a value by weighing the relative importance of the feature and normalizing the feature. When the feature adjustment score is multiplied by the FAF and by the comp modified sale price, the result is the feature adjustment value that is valued in dollars;
s) Weighing each comp adjusted sale price according to how similar each comp is to the subject based on the total net adjustment amount;
t) Employing data quality and data cleaning techniques to identify and resolve, missing or out-of-range feature values. These include ensuring that data are accurate, repaired when needed, and generated when missing, as well as employing text cleaning techniques to clarify and improve the meaning of text data;
u) For at least some prior valuations of subject properties, testing the accuracy of overall appraisals, comp selection, feature scoring, and feature adjustment fractions (weights) by substituting and rotating comps for the subject property in order to compare the estimated appraisal with the actual comp sale price;
v) For at least some prior valuations of subject properties, monitoring MLS databases and other sources for the sale of such subject properties to compare the accuracy of the estimated valuation with the actual modified sale price for future analysis and improvement; and
w) Soliciting and acquiring customer feedback on the user experience (UX) including, at a minimum, ease of use, product and feature favorability, and comparison with competing products.

One or more valuation methods described herein comprises: accessing comparison property data from a comparison property database, wherein the comparison property data includes comparison property identifiers for a plurality of comparison properties and a plurality of features, and each comparison property identifier corresponds to at least one feature from among the plurality of features; selecting a set of comparison properties from the plurality of comparison properties, and selecting a set of features from the plurality of features; and executing a set of computer-executable instructions stored on one or more non-transitory computer readable media, wherein when executed by at least one processor, the computer-executable instructions carry out the following steps: assigning or calculating a numeric feature score to each feature in the selected set of features for each comparison property in the selected set of comparison properties; adjusting each feature score for each feature in the selected set of features for each comparison property in the selected set of comparison properties; converting feature adjustment scores into a set of feature adjustment values, each feature adjustment value in the set of feature adjustment values corresponding to a selected feature in the set of features and a comparison property from among the set of comparison properties; and valuating the subject property based on the totality of feature adjustment values to yield a valuation of the subject property.

The comparison and adjustment of features carried out by executing the set of computer-executable instructions in the above at least one embodiment may further comprise: assigning a similarity score to each comparison property, wherein the assigned ranking is indicative of a degree of similarity of the corresponding comparison property and the subject property based on one or more features; applying an exponential decay formula to calculate a feature score for at least some features in the set of features; and/or applying the Likert scale or another psychometric scale to grade subjective judgments as a numeric ranking for at least some features in the selected set of features.

The step in the above at least one embodiment of assigning a numeric feature score to each feature comprises: applying text analysis and text mining to a plurality of comp listings in a multiple listing service, wherein the multiple listing service is a service comprising a database of properties, wherein the database comprises the plurality of listings, and wherein each of the listings in the plurality of listings represents a different comparison property from among the plurality of comparison properties; and/or applying nominal value scores to a plurality of attributes within at least one feature in the selected set of features.

With respect to real estate, it should be appreciated that one non-limiting example of a multiple listing service is the MLS service, which is a database of real estate properties that brokers use to establish contractual sale offers and historical property sales, and to accumulate and disseminate information to enable appraisals of other real estate properties that are either on the market or will soon be on the market.

The step in the aforementioned at least one embodiment of valuating the subject property based on the feature adjustment values further comprises adjusting the valuation of the subject property based on current market conditions by considering factors such as, for example, average days on market (DOM); average listing price vs. contract price; sale price trends; seasonality; demand (sales for the last month, year over year); inventory (supply of houses listed for sale (in days) based on demand); regional/local average housing sale prices (year over year); percent of real estate owned by banks (REO); percent of short sales; and percent of rentals.

The aforementioned at least one embodiment may further comprise: utilizing sales data from, for instance, a multiple listing service database, to adjust for sale price differences over time between sale of a comparison property and current sale prices. In this step, the sales price for a comp is adjusted to account for a change in value between the date of sale of the comp and the date of the subject property's estimated value. The adjusted sales price is then used in all formulas for comp values that include a sales price, rather than utilizing the unadjusted sales price for the given comp.

The aforementioned at least one embodiment may further comprise: saving and storing data after one or more of the method steps recited herein, including, for instance, storing at least one of the features from the selected set of features and storing the numeric feature scores corresponding to the selected set of features; and/or reviewing a set of past valuations made by the method.

In at least one embodiment of an automated system for valuating a subject property, the system comprises: at least one computer comprising at least one processor operatively connected to at least one non-transitory, computer readable medium, the at least one non-transitory computer readable medium having computer-executable instructions stored thereon, wherein when executed by the at least one processor the computer executable instructions carry out a set of steps defining an automated valuation model for appraising and valuing a subject property, the steps in the set of steps comprising: selecting a set of comparable properties; defining a set of features for the subject property, the set of features comprising a plurality of features of the subject property, for each comparison property in a selected set of comparison properties, assigning or calculating a numerical feature score to each feature in the set of features; for each comparison property in the selected set of comparison properties, comparing each feature of each comparison property with the subject and adjusting each numeric feature score accordingly; calculating a feature adjustment value for the each feature in the set of features; and valuating the subject property based on the feature adjustment values of the comparison properties in the selected set of comparison properties.

The steps in the set of steps in at least one embodiment of the system further comprises: assigning a ranking to each comparison property in the selected set of comparison properties, wherein the assigned ranking is indicative of a degree of similarity of the corresponding comparison property and the subject property based on one or more characteristics; applying one or more exponential decay formulas; applying Likert scale measurements to grade and numerically rank subjective judgments for at least some features in the set of features; applying text analysis to a plurality of listings in a multiple listing service, wherein the multiple listing service is a service comprising a database of properties, wherein the database comprises the plurality of listings, and wherein each of the listings in the plurality of listings represents a different property; applying nominal value scores to a plurality of attributes within a feature in the set of features; utilizing sales data to adjust for sale price differences over time between date of sales of the comparable properties and date of the subject valuation; and adjusting valuation of the subject property based on current market conditions by considering factors including, but not limited to, average days on market (DOM), average listing price vs. contract price, sale price trends, seasonality, demand (sales for the last month, year over year); inventory (supply of houses listed for sale (in days) based on demand); regional/local average housing sale prices (year over year); percent of real estate owned by banks (REO); percent of short sales; and percent of rentals.

At least one embodiment of the system further comprises a dictionary comprising a plurality of real-estate terms used in selling property, and a term matrix capable of isolating commonly-used terms in the plurality of real-estate terms. Specifically, the term matrix is based on text information from various fields, such as, for instance, the “Remarks” field in a multiple listing service listing. It should be appreciated that the system can be configured to generate the term matrix automatically or, alternatively, the fields can be analyzed manually with text analytics and text mining tools to evaluate salience, sentiment, and polarity. Such text analysis may indicate the need for additional adjustments to the automated valuation model that can then be applied to increase the accuracy of the model.

In at least a further embodiment of a system for valuating a subject property, the system comprises at least one computer comprising at least one processor, wherein the at least one processor is operatively connected to at least one non-transitory, computer readable medium having a plurality of computer executable programs stored thereon, the plurality computer executable programs comprising: a feature definer, wherein when executed by the at least one processor, the feature definer defines a set of features for the subject property, the set of features comprising a plurality of features of the subject property; a score assigner, wherein when executed by the at least one processor, for each comparison property in a selected set of comparison properties, the score assigner assigns a numerical feature score to each feature in the set of features; a feature adjuster, wherein when executed by the at least one processor, for each comparison property in a selected set of comparison properties, the feature adjuster adjusts each feature score to produce a feature adjustment value for the each feature in the set of features; and a valuation calculator, wherein when executed by the at least one processor, for each comparison property in a selected set of comparison properties, the valuation calculator valuates the subject property based on the feature adjustment values.

In at least one embodiment of the above-mentioned system, one or more of the plurality of computer executable programs defines an automated valuation model for appraising and valuing the subject property.

In at least one embodiment of a system for predicting value of one or more items, the system comprises at least one computer comprising at least one processor, wherein the at least one processor is operatively connected to at least one non-transitory, computer readable medium having a plurality of computer executable programs stored thereon, the plurality computer executable programs comprising: a data compiler, wherein when executed by the at least one processor, the data compiler compiles data from one or more past sales, and the one or more past sales are of items belonging to a same category as that of one or more items to be valuated; a data analyzer, wherein when executed by the at least one processor, the data analyzer analyzes the one or more past sales; and a prediction engine, wherein when executed by the at least one processor, the prediction engine predicts a value of the one or more items to be valuated based on the analyzed data from the one or more past sales.

One of skill in the art will appreciate that one or more of the above-disclosed embodiments of the present disclosure may be used to provide valuations for personal property items, including, but not limited to, vehicles, fine art, decorative art, musical instruments, and other saleable objects; intellectual property, including but not limited to, patents, copyright, trademarks, systems and methods, human capital, software programs, databases, and digital content; and financial instruments, such as, for instance, publicly-offered securities, initial public offerings (IPOs), secondary offerings, and mergers and acquisitions.

At least another embodiment of the disclosure relates to valuating commercial real estate properties, which may comprise a different set of features, including, but not limited to, additional features such as the income method for property valuation, frontage, type of business, equipment and design for the type of business, disability access, and ease of parking.

It should be appreciated that the embodiments relating to real estate may also be applied to embodiments or applications other than valuating the sale of real estate, including, for example, valuating rental properties. A skilled artisan will recognize that various features may be adjusted for valuating rental properties, such as, for instance, changing (1) Sale price to (1) Rental price, and deleting (2) Concessions and (3) Modified Sale Price.

An additional embodiment for fine art is presented in Example 3, demonstrating how the same systems and methods can be applied with a differing set of features to valuate properties in an entirely separate domain/embodiment. For this fine art embodiment, some of the comp selection criteria may also serve as features for comparison and valuation.

These and further and other objects and features are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. Embodiments of the disclosure will be more particularly described in conjunction with the following drawings wherein:

FIG. 1 is a block diagram illustrating the Sales Comparison Approach (SCA), an appraisal method currently known in the art.

FIG. 2 is a block diagram illustrating an exemplary automated method for assessing and valuating property, in accordance with one or more implementations of the present disclosure.

FIG. 3 is a block diagram illustrating an exemplary automated system for assessing and valuating property, in accordance with one or more implementations of the present disclosure.

FIG. 4 is a block diagram illustrating another exemplary automated system for assessing and valuating property, in accordance with one or more implementations of the present disclosure.

FIG. 5 is a block diagram illustrating exemplary additional steps that may be used by the systems and methods described herein for assessing and valuating the subject property, in accordance with one or more implementations of the present disclosure.

FIG. 6 is a block diagram illustrating an exemplary automated system for predicting the appraisal value of an item, in accordance with one or more implementations of the present disclosure.

FIG. 7 is a schematic diagram illustrating an exemplary computer system for executing the systems and methods described herein for assessing and valuating the subject property, in accordance with one or more implementations of the present disclosure.

FIG. 8 is a block diagram illustrating an exemplary sequence of actions taken by both a user and an automated valuation model in order to assess and value the subject property, in accordance with one or more implementations of the present disclosure.

### DETAILED DESCRIPTION

Systems and methods for assessing and valuating property, including, for instance, real property, personal property, intellectual property, and financial instruments, will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, characteristic, or computation. Such phrases are not necessarily referring to the same embodiment. When a particular feature, structure, or characteristic is described in connection with an embodiment, persons skilled in the art may affect such feature, structure, characteristic, or computation in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present disclosure can be carried out in a variety of ways, and does not require any particular number of the specific features described herein. Also, well-known functions or constructions are not described in detail since they would obscure the invention with unnecessary detail. Any signal arrows in the drawings/figures should be considered only as exemplary, and not limiting, unless otherwise specifically noted.

The description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a,” “an,” and “the” are intended to include the plural forms as well, unless the context clearly indicates otherwise.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

In general, the word “instructions,” as used herein, refers to logic embodied in hardware or firmware, or to a collection of software units, possibly having entry and exit points, written in a programming language, such as, but not limited to, Python, R, Rust, Go, SWIFT, Objective C, Java, JavaScript, Lua, C, C++, or C#. A software unit may be compiled and linked into an executable program, installed in a dynamic link library, or may be written in an interpreted programming language such as, but not limited to, Python, R, Ruby, JavaScript, or Perl. It will be appreciated that software units may be callable from other units or from themselves, and/or may be invoked in response to detected events or interrupts. Software units configured for execution on computing devices by their hardware processor(s) may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. Generally, the instructions described herein refer to logical modules that may be combined with other modules or divided into sub-modules despite their physical organization or storage. As used herein, the term “computer” is used in accordance with the full breadth of the term as understood by persons of ordinary skill in the art and includes, without limitation, desktop computers, laptop computers, tablets, servers, mainframe computers, smartphones, handheld computing devices, and the like.

In this disclosure, references are made to users performing certain steps or carrying out certain actions with their client computing devices/platforms. In general, such users and their computing devices are conceptually interchangeable. Therefore, it is to be understood that where an action is shown or described as being performed by a user, in various implementations and/or circumstances the action may be performed entirely by the user's computing device or by the user, using their computing device to a greater or lesser extent (e.g. a user may type out a response or input an action, or may choose from preselected responses or actions generated by the computing device). Similarly, where an action is shown or described as being carried out by a computing device, the action may be performed autonomously by that computing device or with more or less user input, in various circumstances and implementations.

In this disclosure, various implementations of a computer system architecture are possible, including, for instance, thin client (computing device for display and data entry) with fat server (cloud for app software, processing, and database), fat client (app software, processing, and display) with thin server (database), edge-fog-cloud computing, and other possible architectural implementations known in the art.

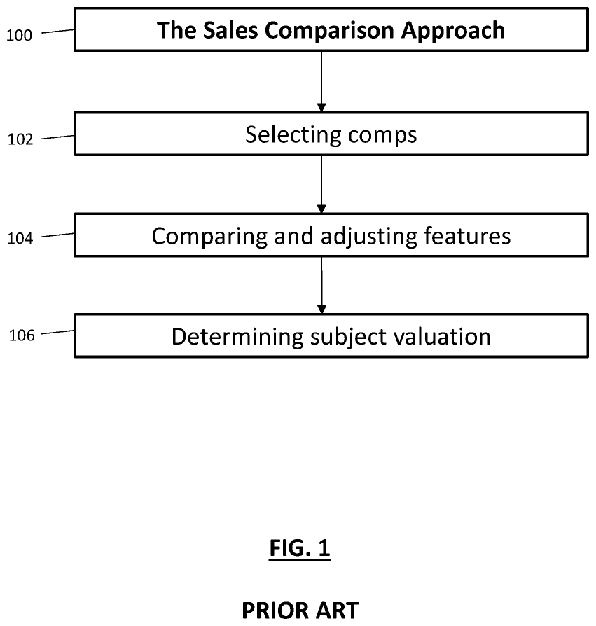

As shown in FIG. 1, the aforementioned SCA 100 consists of 3 steps: selecting comps 102, comparing and adjusting features 104, and determining subject valuation 106. These steps are described in further detail below.

1) Selecting Comps 102:
a. Select a pool of potential comps based on a plurality of search criteria from the universe of properties that are sold, under contract, or listed for sale.
b. Filter the pool down into a set of the most similar and relevant comps (a plurality of comps) for further processing in steps two and three.

2) Comparing and Adjusting Features 104:
a. Source property features from, e.g., MLS database, observation, previous appraisals, etc.
b. Select features based on importance and relevance to the subject and comps.
c. Evaluate and assign a score to the selected features for the subject and each comp.
d. Compare and adjust the selected features by taking the difference between the subject and comp feature scores.

3) Determining the Subject Valuation 106:
a. Assign a monetary value to each comp feature adjustment.
b. Sum the feature adjustments and the comp modified sale price into an adjusted sale price for each comp.
c. Determine the subject's final valuation by comparing the adjusted sale prices for each comp.

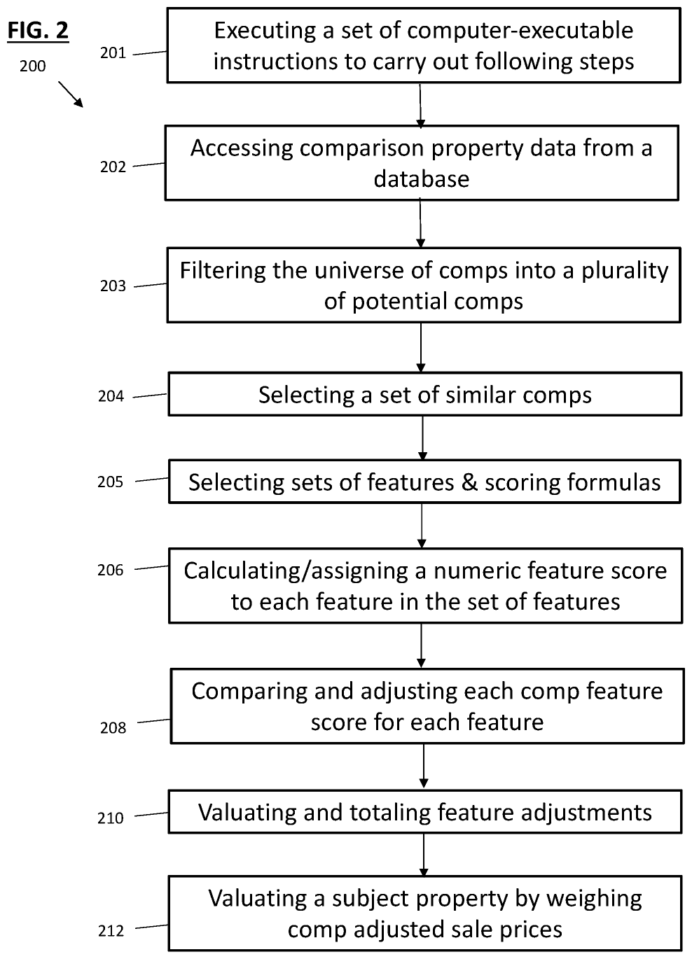

Turning now to FIG. 2, a block diagram illustrating an exemplary automated valuation method (AVM) 200 for assessing and valuating property, in accordance with one or more implementations of the present disclosure, is shown. Generally, the method 200 comprises a step 201 of executing a set of computer-executable instructions to carry out the following steps: accessing property data 202; filtering comps 203; selecting similar comps 204; selecting sets of features and scoring formulas 205; calculating numeric feature scores 206; comparing and adjusting features 208; valuating and totaling feature adjustments 210; and valuating the subject property 212.

The method 200 first starts with a step 201 of executing a set of computer-executable instructions stored on one or more non-transitory computer readable media, wherein, when executed by at least one processor, the computer-executable instructions carry out the following steps.

In the step 202 of accessing comparison property data from a comparison property database, the comparison property data includes comparison property identifiers for a plurality of comparison properties and a plurality of features, and each comparison property identifier corresponds to at least one feature from among the plurality of features.

Step 203 then filters the universe of comparison properties (or “comps,” i.e., properties comparable to the subject property) into a plurality of potential comps. Comp filtering may be based on a variety of criteria, including, for example, location proximity, property type, time proximity, and transaction type.

It should be appreciated that the step 203 may comprise separate sub-steps, including, for instance, first identifying potential comparison properties by filtering and then comparing and selecting from those potential comps into a set of similar comps. This selected plurality of comps is then used in further steps of the described method.

The method at step 203 may identify potential comps by searching one or more databases based on various search criteria, which may be user-defined or pre-established with one or more search templates. These criteria are set in order to produce potential comps that have similar characteristics to the subject property. First, a set of potential comps is found using various characteristics such as, for instance, property type, transaction type, location proximity, and time proximity. After a search result is returned, and sufficient potential comps are identified, the method at step 204 may then compare and select from those potential comps into a set of similar comps. Such filtering may be accomplished by comparing selected features (e.g., GLA, Modified Sale Price, etc.) of the subject and potential comps.

The following is a non-limiting example of step 203 and the selection of potential comps based on the following parameters: property type, transaction type, location proximity, and time proximity.

With respect to the property type feature, the method at step 203 may divide potential comps into various property types. Property types may include, but are not limited to, (1) detached single family homes, (2) attached homes, such as townhouses, row houses, duplexes, or multiplexes with 4 or fewer units, (3) multi-family homes, such as apartments, condominiums, or multiplexes with 5 or more units. Most human appraisers only consider like property types when evaluating potential comps. In some situations, this may result in too few comps to provide an accurate assessment or valuation of the subject property. However, in some implementations, the method prohibits the consideration of potential comps across multiple property types because the feature differences are too many and too great to result in an accurate valuation.

Additionally, with respect to the transaction type feature, the method at step 203 may select only potential comps that have been sold according to a certain transaction type, such as, for example, (1) a standard sale (also known as an arms-length market transaction), (2) a distressed sale, such as a short sale, real estate owned (REO) sale, or foreclosure, (3) a contract sale that is not yet settled, either with a so-called “no kickout” clause or with a kickout clause, and (4) listings for sale. Information regarding such sales or transaction types can be found at, for instance, property listings or multiple listing service databases. Currently, human appraisers often allow consideration of properties that are not arms-length market transactions as potential comps, including, for example, short sales, listings for sale, etc. Such consideration may cause errors in the ultimate valuation of the subject property since one or more comps have been sold as a different transaction type, which may have different sale ranges or market parameters, then a standard arms-length market transaction. Therefore, as a non-limiting example, the transaction type filter results in only properties with arms-length sales being selected for further consideration. Should there be insufficient potential comps for subsequent processing, no kickout (NOKO) contracts, i.e., contracts without contingencies, may be included as allowable transaction types.

Further, with respect to the location proximity feature, the method at step 203 may determine which potential comps are located within (1) a certain radius of the subject property such as, for example, 0.25 mile, 0.5 mile, 1.0 mile, 2.0 miles, or 5.0 miles, (2) the same subdivision or neighborhood as the subject property, (3) the same building as the subject property (such as for condominiums or apartments), or (4) any other user-defined area. Based on the location, the method may select appropriate properties from which to select a plurality of comps. Purely as a non-limiting series of examples, if the subject property is located in a suburban environment, potential comps can be restricted to within a 1.0 mile radius of the subject property. If, however, the subject property is located in an urban environment, potential comps can be restricted to within a 0.25 to 0.5 mile radius of the subject property. Finally, if the subject property is located in a rural environment, potential comps can be restricted to within a 2 to 5 mile radius of the subject property. Should there be insufficient properties for subsequent processing, the location proximity may be expanded by the user or system to generate sufficient potential comps.

Lastly, with respect to the time proximity feature, the method at step 203 may select potential comps from properties that were bought or sold within a certain time frame. Purely as a non-limiting example, the time proximity feature can be defined by (1) subtracting the date of sale of each potential comp from the date on which the user is running the method 200, or (2) subtracting the contract date of a potential comp from the date on which the user is running the method. Additionally, the user may set the time frame to a specific period of time, such as, for instance, 180 days or one year. It should be appreciated that manual time frame adjustment by the user may result in the generation of a sufficient number of potential comps, such as, for example, greater than 50 properties. Should there still be insufficient properties for subsequent processing, the time frame may be expanded up to two years by the user or system to generate sufficient potential comps. It should be appreciated that embodiments of this disclosure account for, and adjust, comp sale prices to account for changes in local average sale prices over time due to price trends and seasonality based on area historical sales, and also adjust for current market conditions.

This step 203 in selecting a plurality of potential comps may involve searching for properties that have the same values with respect to property type, transaction type, location proximity, and/or time proximity as the subject property. Purely as a non-limiting example, potential comps in a suburban location may be restricted to those properties that (1) have the same property type as the subject property, (2) were the subject of a standard arms-length market sale transaction, (3) are within 1.0 mile of the subject property, and (4) were sold within the past 180 days. It should be appreciated that the aforementioned example is only one specific exemplary method of executing step 203.

It should therefore be appreciated that in selecting comps in step 203 that there may be situations in which there are too few potential comps to adequately execute the method 200. In executing step 203, the number of potential comps after the search is preferably at least 25 properties. It should be appreciated that there may be situations in which there are too few potential comps. In such a situation, a user or the system can expand the search for potential comps by broadening one or more of the transaction type, location proximity, and/or time proximity parameters. For instance, a user could expand the location proximity parameter to include all properties within 1.5 miles, rather than 1.0 mile, of the subject property. As another non-limiting example, a user or the system could expand the time proximity parameter from 180 days to include all potential comps with a sale date of within the past 365 days.

After searching and filtering for potential comps, the next step 204 entails selecting a set of similar comps from the plurality of potential comparison properties. This set of selected comps are those most similar to the subject property and therefore the ones selected for further comparison with the subject (see, for instance, Example 1 below herein). The set of comps can be generated by, for instance, using the gross living area (GLA) measurement and the property's sale price. An analysis of GLA can be done by subtracting the GLA of each potential comp from the GLA of the subject property and taking the absolute value of the difference (“GLA Difference”). The GLA Difference can then be divided by the GLA of the subject property to produce a percentage difference in GLA (“Percent GLA Difference”).

A similar calculation can be done with reference to sale price, but first an imputed sale price can be calculated for the subject property. For each potential comp, the concessions can be subtracted from the sale price to produce a modified sale price. Next, the modified sale prices for the comps with the five closest GLAs to the subject are averaged and the average sale price can be set as the Imputed Sale Price of the subject. Then, for each potential comp, the modified sale price can be subtracted from the subject's Imputed Sale Price, and the absolute value of this difference can be taken (“Sale Price Difference”). Finally, the Sale Price Difference can be divided by the Imputed Sale Price, resulting in a percentage difference in sale price (“Percent Sales Price Difference”).

These two quantities, Percent GLA Difference and Percent Sales Price Difference, can be combined in order to select a set of comps. For each potential comp, the Percent Sales Price Difference and the Percent GLA Difference can be added together, resulting in a combined percentage difference (“Combined Percent Difference”). The set of comps is then chosen from those properties with the lowest Combined Percent Difference scores. In some embodiments of the disclosure, up to seven comps are chosen to comprise the set of comps. In some embodiments of the disclosure, selected comps may be restricted to less than 20% of the Combined Percent Difference to prevent comparison of properties that are too dissimilar.

One of skill in the art will appreciate that the method described herein allows for the removal of comps that are outliers. Purely as a non-limiting example, the method is capable of removing comps that have a modified sale price of more than 10% above, or more than 10% below, a mean sales price. Such removal of outliers is often not done, leading to the usage of comps that are out of line with fair market value or that may have significant differences in features from the subject property. One of skill in the art will appreciate that outliers may result from failure to consider how well a given property shows, including the type and condition of a property's furnishings, décor, staging, current stylistic preferences, and neatness and cleanliness, even though this factor may affect market value by up to 15%. Unfortunately, in many jurisdictions, appraisers are not allowed to explicitly consider this factor in their valuation because the furnishings, décor, and the like are not considered fixtures of the property. Further, realtors occasionally purposefully lowball the asking sale price on a property listing in order to sell the property faster. Outliers may occur for a variety of other reasons, including, but not limited to, imbalances in the market, such as when there is a shortage of buyers or a shortage of sellers, or an excessive number of short sales, REOs, or rentals.

Subsequent steps include a step 205 of selecting sets of features, corresponding feature scoring formulas, and feature adjustment fractions; a step 206 of calculating/assigning a numeric feature score to each feature in the selected set of features for each comparison property in the selected set of comparison properties; a step 208 of comparing and adjusting each feature score for each feature in the selected set of features for each comparison property in the selected set of comparison properties, thereby producing a set of feature adjustment scores, each feature adjustment score in the set of feature adjustment scores corresponding a selected feature in the set of features and a comparison property from among the set of comparison properties; a step 210 of weighting for relative importance, scaling, and monetizing each feature adjustment score into a feature adjustment value, and totaling these feature adjustment values into an adjusted comp sale price; and a step 212 of valuating the subject property based on, as a non-limiting example, weighing the relative amount of feature adjustment values for each comp to yield a valuation of the subject property.

The method determines numeric feature scores and feature adjustment values for the following non-exhaustive list of features in situations where the subject property is residential real estate:

(1) Sale price;

(2) Concessions;

(3) Modified sale price (calculated by subtracting the concessions value from the sale price value);

(4) Bedrooms;

(5) Bathrooms;

(6) Flooring;

(7) Fireplace;

Some further features require data from external sources in order to score the feature:

(8) Nearby Amenities (i.e., the availability of nearby parks, stores, shopping, restaurants, and medical facilities);

(9) Contract Date Adjustment;

(10) Current Market Conditions;

Additional features have categorical symbolic entries that describe a quality of that feature. Entries are classified into numeric scores based on relative favorability according to current buyer and/or market preferences:

(13) Property style (i.e., differences in house styles, such as, for example, Colonial, Victorian, contemporary, split-level, etc.);

(15) Exterior finish (e.g., stone, brick, shingle, stucco, etc.);

(17) Parking (e.g., one-car garage, two-car garage, carport, urban off-street parking, parking lot, street parking, etc.);

(18) Street traffic.

Additional features have multiple aspects and/or attributes that are awarded scores, which are then totaled into an overall feature value, including, but not limited to, the following:

(11) Basement features;

(12) Energy;

(14) Remodeling;

(16) Exterior features (e.g., deck, porch, patio, balcony, fence, shed, gazebo, outbuilding, pool, etc.);

An exponential decay formula may be applied for further features that include one or more physical areas, relative dates or time, and/or age of a property. Such an exponential decay formula is useful in accounting for the value of features that have an amount of diminishing return or depreciation over time. A non-limiting example of an exponential decay formula is (1-x)^{(F)} where “x” is the exponential decay rate and “F” is the value of the given feature. Non-limiting examples of features for which an exponential decay formula may be applied include, but are not limited to:

(19) Gross Living Area (GLA);

(20) Basement finished living area;

(21) Basement unfinished living area;

(22) Lot size;

(23) Property age;

(24) Days on market (i.e., the age of the property listing).

Some features, such as, for instance, the following features, are measured on a Likert scale with a rating of 1 to 7:

(25) Quality of construction;

(26) Condition (e.g., based on inspection, photos, and text analysis of remarks in a property's listing in a multiple listing service);

(27) How well shows (i.e., how well the property appeals to potential buyers including current buyer preferences in style, furnishings, décor including wall colors, neatness, and cleanliness);

(28) Site landscaping;

(29) Neighborhood;

(30) School quality; and

(31) Remarks (e.g., based on textual observations or remarks in a property's listing in a multiple listing service and/or other available sources).

As can be seen from the above listings of features, the method may take into account at least 31 features in the set of features on which to base evaluation and pricing of both the plurality of comps and the subject property. All feature inputs, whether in the form of numeric, categorical symbols, or text, are converted into numeric feature scores prior to comparing features. Further, it should be apparent that some features may be represented by discrete integers, such as, for instance, the Sale Price or Concessions. Others, such as Neighborhood, may be represented by scale rankings based on, for instance, the Likert scale. Still other features may be converted from categorical inputs or text into assigned numeric scores reflective of general market desirability, such as the Property Style feature. Further features may be represented by the summed scoring of aspects and/or attributes within a feature, such as Basement Features.

It should be appreciated that, for each of the above features, the present disclosure explicitly calculates the difference between the feature score for each of the plurality of comps and the feature score for the subject property. By contrast, human appraisers often undervalue or ignore many of these features and their differences due to the difficulty of such scoring and the like.

It should be further appreciated that the above list of features may be applied to embodiments or applications other than valuating the sale of real estate, including, for example, valuating rental properties. A skilled artisan will recognize that various features may be adjusted for valuating rental properties, such as, for instance, changing (1) Sale price to (1) Rental price, and deleting (2) Concessions and (3) Modified Sale Price.

As stated above, the method at step 201 comprises executing a set of computer-executable instructions stored on one or more non-transitory computer readable media, the computer-executable instructions carrying out, inter alia, the step 206 of calculating/assigning a numeric feature score to each feature in the set of features. Such a feature score is an indicator of the value of a particular feature for a particular comparison property. Feature scores are not necessarily on the same scale, or normalized, across all possible features.

Certain exemplary features in the set of features have numeric values that can be extracted directly from listings in a multiple listing service, such as, for instance, the MLS database. Such features include, for instance, (1) Sale price, (2) Concessions, (4) Bedrooms, (5) Bathrooms, (7) Fireplace, (19) GLA, (20) Basement finished living area, (21) Basement unfinished living area, (22) Lot size, (23) Property age, and (24) Days on market.

Some features in the set of features have feature scores that depend on summing a number of attributes based on their presence. These features include, for instance, (6) Flooring, (11) Basement features, (12) Energy, (13) Property style, (14) Remodeling, (16) Exterior features, (17) Parking, and (18) Street traffic.

Various other features in the set of features have feature scores that depend on subjective or relativistic scales, such as, for instance, the Likert scale. These features include, for instance, (8) Nearby Amenities, (25) Quality of construction, (26) Condition, (27) How well shows, (28) Site landscaping, (29) Neighborhood, and (30) School quality.

It should be appreciated that the numeric feature score for various features in the set of features may be entered by the user, including, for example, (14) Remodeling, (15) Exterior finish, (18) Street traffic, (25) Quality of construction, (26) Condition, (27) How well shows, (28) Site landscaping, and (29) Neighborhood.

The feature scoring step 206 relies on data relating to the various features, data which can come from multiple sources. Entry of such data for the purposes of one or more embodiments of the disclosure may be either manual or automated. For example, information on the Sale Price, Concessions, Property Age, etc. can be automatically extracted from a multiple listings service database. Other external databases or sources can be used for features that reflect desirability (e.g., School Quality). Features that require subjective judgments, including those based on the Likert scale, are based, in part, upon textual remarks or phrases present in, for instance, multiple listing service databases, previous appraisals, insurance and mortgage company remarks, physical inspection reports, and the like. Further, previous subjective judgments (e.g., by appraisers, realtors, online ratings, etc.) can be taken into account in scoring some of the aforementioned features.

One or more scoring algorithms (e.g., exponential decay, polynomial regression, etc.) may also be used for one or more features. The score for other features, such as Bedroom and Bathroom, are simply a raw numeric score that can be assigned directly or by evaluating the data sources mentioned above. The score for still other features, such as Exterior Finish, is an assigned score that reflects the favorability of the various feature options (e.g., stone or shingle in the case of Exterior Finish) in the current market environment. The score for still further features is a ranking number, such as a score of 1 being the best and 7 being the worst for features (e.g., Quality of Construction) utilizing the Likert scale.

The method may also comprise utilizing data quality and data cleaning techniques to identify, and resolve, missing or out-of-range feature entries. One of skill in the art will also recognize that data cleaning techniques may be employed to ensure that data are accurate, that data entries are repaired when needed, that data entries are generated when missing, and that the meaning of textual data is clear.

It should further be appreciated that various data cleaning remediation methods can be used. Most feature data can be downloaded from a multiple listing service database or other databases. When feature data contains missing information, a remediation method can often be applied to insert a substitute score. If, as a non-limiting example, a given feature entry is missing, an alternate feature entry may be provided by, for example, other databases, records, prior appraisals, individual inquiry, examination of photos, and/or observation. A default feature score may also be entered. If no such default score exists, the median or mean score for the feature from the other comps can be used, at least for features that have numeric and cardinal feature scores.

In other words, if the subject property is missing a feature entry for objective features that normally have numeric values, and if no default value exists, the median score or mean score for the feature can be substituted from the plurality of comps. If one of the comps itself is missing a feature entry, the median score or mean score for the feature can be similarly substituted from the remaining comps, with or without the subject score.

It should also be appreciated that, if no feature entry exists for a given feature for a given comp, that feature will be ignored for that comp by the method 200. If no feature entry exists in the subject, and if no default entry can be determined, that feature is ignored for all comps.

For possible out-of-range feature entries, threshold scores can be predetermined for some features, and outlier scores can be flagged for correction. Correction may comprise, for instance, ignoring the feature adjustment or entering a default score. When there is no default score established, the median or mean score from the plurality of comps can be substituted. As a non-limiting example, in Example 1 below herein, six out of seven of the comps had a GLA of 1,400 square feet (SF) and the seventh had a GLA of 2,100 SF. When the seventh comp's cost/SF exceeded the median cost/SF by >25%, this comp's GLA was flagged as a suspicious outlier. Further examination revealed that the seventh comp included a basement finished area of 700 SF in the GLA that is not permitted when determining GLA.

It should be appreciated that, if no feature score exists or it cannot be determined for a given feature for a given comp, the feature can be ignored for adjustment purposes.

Additionally, calculations may result in dividing by 0, which produce incorrect results. A test for a zero-score and/or a near-zero score can be made and, if true, that score can be replaced by a small positive number.

The accuracy of various valuations can be tested by applying a Comp Substitution and Rotation Test method to compare predicted comp property valuations with actual modified sale prices of the comp in previously worked cases. Such a Comp Substitution and Rotation Test method may comprise replacing the subject with a comp property, and rerunning the appraisal or valuation. In turn, each comp from the original appraisal replaces the subject and the comp estimated appraisal sale from running the appraisal is compared to the actual comp sale price. The average difference between predicted and actual comp valuations is the overall error rate. Then, comps with the largest differences between the estimated and actual comp modified sale prices, as well as comps with the largest feature adjustment values, can be identified for possible improvement. These identified comps, features, and/or corresponding feature adjustment fractions (weights) are then analyzed to further improve results, systems, methods, and parameter values in comp selection, feature scoring, and valuation.

The computer-executable instructions of step 201 additionally carry out the step 208 of comparing and adjusting each numeric feature score to produce a Feature Adjustment Score (FAS) for each feature in the set of features for each comp. Then, in step 210, applying the feature adjustment fraction (FAF) takes a dimensionless numeric feature adjustment score as input and converts it to a value by weighing the relative importance of the feature, scaling the feature, and monetizing the feature. When a feature adjustment score is multiplied by the FAF and by the comp modified sale price, the result is a Feature Adjustment Value (FAV) that is valued in dollars.

Calculating such Feature Adjustment Values may proceed as follows, in a non-limiting example.

First, a formula, referred to herein as a Feature Adjustment Value Formula, is applied to each numeric Feature Adjustment Score to produce an adjustment value for each feature as set forth below:

FAV(i,j)=FAS(i,j)×FAF(j)×P(i) (1)
where i is a dimensionless index value corresponding to a particular comparison property ranging from 1 to n;
   j is a dimensionless index value corresponding to a particular feature ranging from 1 to m;
   FAV(i,j) is the Feature Adjustment Value of the jth feature for the ith comp resulting from the formula that converts the FAS into the FAV;
   FAS(i,j) is the input numeric feature adjustment score of the jth feature for the ith comp (dimensionless);
   FAF(j) is the Feature Adjustment Fraction for the jth feature that converts the feature adjustment score into a feature adjustment value by weighing, scaling, and monetizing the score; and
   P(i) is Comp Modified Sale Price for the ith comp that scales and monetizes the FAS.

Sample Feature Adjustment Scoring Formulas fj(FAS(i,j) that determine the resulting FAS(i,j) are provided below for various features in the exemplar set of 31 features set forth previously herein.

(4) Bedrooms=number of bedrooms of the subject−number of bedrooms of the comp.

(5) Bathrooms=number of bathrooms (including half-bathrooms) of the subject−number of bathrooms (including half-bathrooms) of the comp.

(6) Flooring=flooring score of the subject−flooring score of the comp. The flooring score scale is as follows: wood=2, tile=1, carpet=0.

(7) Fireplace=number of fireplaces of the subject−number of fireplaces of the comp.

(8) Nearby Amenities=Nearby Amenities score of the subject−Nearby Amenities score of the comp (based on, e.g., availability of nearby recreation, parks, shopping, stores, restaurants, and medical facilities).

(9) Contract Date Adjustment: e.g., scoring in percentage change in local prices in the relevant metro area or zip code over time difference between the Contract Date and Analysis Date (in days)/30; in months from available sources.

(10) Current Market Conditions: Scoring includes, for instance, average days on market (DOM), average listing price vs. contract price, sale price trends, seasonality, demand (sales for the last month, year over year); inventory (supply of houses listed for sale (in days) based on demand); regional/local average housing sale prices (year over year); percent of real estate owned by banks (REO); percent of short sales; and percent of rentals.

(11) Basement features=basement feature score of the subject−basement feature score of the comp. The basement feature score scale is as follows: walkout basement=1.5, outside entrance=1, recreation room=1; bedroom present=0.5, bathroom present=1, kitchen present=1.5, wine cellar=1, home theater=1.5, sump pump=−2. One of skill in the art will appreciate that any given basement may have one or more of these variations, for which the basement score will be the sum of all the variations present.

(12) Energy=energy score of the subject−energy score of the comp. The energy score is the sum of the heating score, the cooling score, and the energy efficiency score. The heating score scale is as follows: natural gas=0, radiators=1.5, baseboard=1, oil/propane=−2, heat pump=−4, electric resistance=−8. The cooling score scale is as follows: with central air conditioning (CAC)=0, CAC with Scroll Energy Efficiency Rating (EER) 16+=2, CAC with 2-zone system=1, window air conditioning=−4, no air conditioning=−10. The energy efficiency score scale is as follows: super insulation=+5, sub-standard insulation=−5, single-glazed windows=−5, solar photo-voltaic panels=+4.

(13) Property style=style score of the subject−style score of the comp. As a non-limiting example, the style score scale is as follows for the Eastern United States based on current buyer and/or market preferences: colonial=3, craftsman=3, bungalow=3, special/historic=4, deco=1, contemporary=1, Cape Cod=1, rambler=0, split level=−0.5, split foyer=−1, ramshackle=−2.

(14) Remodeling=remodeling score of the subject−remodeling score of the comp. The remodeling score scale is as follows: major remodeling=5, minor remodeling=2, master suite present=1, large kitchen with island present=1, open floor plan=1.

(15) Exterior finish=exterior finish score of the subject−exterior finish score of the comp. The exterior finish score scale based on current buyer and/or market preferences is as follows: stone=1.5, brick=1, shingles=1, mixed brick/siding=0.5, smooth/stucco=0.5, siding=0.

(16) Exterior features=exterior features score of the subject−exterior features score of the comp. This feature is represented by the summed scoring of attributes present within a feature. The exterior attributes score scale is as follows: porch=1.5, deck=1, balcony=0.5, patio=1, fence=0.75, shed=0.5, workshop=1.5, gazebo=1, permanent outdoor cooking/eating station=0.75, pool=4, heated pool=1.

(17) Parking=parking score of the subject−parking score of the comp. The parking score scale is as follows: two-car garage=2, one-car garage=1, carport=0.5, off-street parking=0.3.

(18) Street traffic=traffic score of the subject−traffic score of the comp. The traffic score scale is as follows: located in a cul-de-sac=2, located on an average street=0, located on a street with difficult parking=−2, located on a busy street=−3, located on or next to a highway=−6.

(19) Gross Living Area (GLA) (in SF)=(GLA of the subject)*(decay factor (1−0.0006) raised to the power of (GLA of the subject))−(GLA of the comp)*(decay factor (1−0.0006) raised to the power of (GLA of the comp)), with an exponential decay range of between 0.0004 to 0.0007. As a non-limiting example from Example 2 below herein for a subject property in Northern Virginia with a GLA of 1,106 SF and a relevant comp with a GLA of 1,296 SF, the GLA decay factor=(1-0.0006)=0.9994. The GLA Difference then equals 1,106*0.9994^{(1,106)}−1,296*0.9994^{(1,296)}=−164 SF.

(20) Basement Finished Living Area=(Subject Basement Finished Living Area)*(decay factor (1−0.0006) raised to the power of (Subject Basement Finished Living Area))−(Comp Basement Finished Living Area)*(decay factor (1−0.0006) raised to the power of (Comp Basement Finished Living Area)), with an exponential decay range of between 0.0004 to 0.0007.

(21) Basement Unfinished Living Area=(Subject Basement Unfinished Living Area)*(decay factor (1−0.0006) raised to the power of (Subject Basement Unfinished Living Area))−(Comp Basement Unfinished Living Area)*(decay factor (1−0.0006) raised to the power of (Comp Basement Unfinished Living Area)), with an exponential decay range of between 0.0004 to 0.0007.

(22) Lot Size: If the Lot Size is in fractions of an acre, then the Lot Size in SF Acre=Acre Fraction*43,560. The Lot Size Difference=(Subject Lot Size SF)*(decay factor (1−0.000003) raised to the power of (Subject Lot Size SF))−(Comp Lot Size SF)*(decay factor (1−0.000003) raised to the power of (Comp Lot Size SF)), with an exponential decay range of between 0.000002 to 0.000004.

(23) Property Age (PA)=Current year−year property was built. The PA Difference=(Comp PA Score)*(decay factor (1−0.006) raised to the power of (Comp PA Score))−(Subject PA Score)*(decay factor (1−0.006) raised to the power of (Subject PA Score)), with an exponential decay range of between 0.005 to 0.007. If the PA cannot be ascertained, then a “0” value is entered.

(24) Days on Market (DOM)=sale or contract date of the comp−listing date of the comp. Since the “days on market” value for the subject property is unknown, the average (mean) of the “days on market” score for all comps, or all nearby property listings can be used. Comps with a DOM less than the average DOM score are assumed to sell slightly under market value, and comps with a DOM more than the average score are assumed to sell slightly over the market value. This is accomplished by using exponential decay with the zero center point as the average score of nearby comps. Properties that sell in 1-5 days are assumed to be underpriced by up to 5%. Accordingly, the DOM Difference=(Average DOM Score)*(decay factor (1−0.003) raised to the power of (Average DOM Score))−(Comp DOM Score)*(decay factor (1−0.003) raised to the power of (Comp DOM Score)), with an exponential decay range of between 0.002 to 0.004. If a DOM cannot be ascertained, a value of “0” is entered.

(25) Quality of construction=construction quality score of the comp−construction quality score of the subject. The construction quality score scale is a Likert scale from 1 (best quality) to 7 (worst quality), with 4 being average quality. A new house, however, is rated as −10 in place of the Likert scale score since such a property has additional value since it presumably incorporates current best practices in construction, design, decorating, etc.

(26) Condition=condition of the comp−condition of the subject (e.g., based on inspection and text analysis and text mining of remarks in a property's listing in a multiple listing service). The condition score scale is a Likert scale from 1 (best condition) to 7 (worst condition), with 4 being average condition. As above, a new house is rated as −2 in place of the Likert scale score.

(27) How well shows=score of how well the comp shows−score of how well the subject shows (i.e., how well the property shows to potential buyers including furnishings, décor including wall colors, neatness, and cleanliness). The “how well shows” score scale is a Likert scale from 1 (best showing) to 7 (worst showing), with 4 being average showing. However, if a given property is staged, i.e., is decorated or furnished to appeal to the likely buyer demographic, it is rated as −4.

(28) Site landscaping=site landscaping score of the comp−site landscaping score of the subject. The site landscaping score scale is a Likert scale from 1 (best landscaping) to 7 (worst landscaping), with 4 being average landscaping.

(29) Neighborhood=neighborhood score of the comp−neighborhood score of the subject (based on, e.g., community amenities, views, nuisances, and general condition of neighborhood). The neighborhood score scale is a Likert scale from 1 (best neighborhood) to 7 (worst neighborhood), with 4 being an average neighborhood.

(30) School quality=school quality score of the subject−school quality score of the comp. The school quality score scale is from 1-10 where 10=best, based on the scores given by the GreatSchools website, available at https://www.greatschools.org/.

(31) Remarks: Text from various databases (including, for instance, multiple listings service databases), realtor sales data, appraisals, and the like can be matched to terms in a predetermined term database, analyzed manually, or analyzed by text analysis/text mining software to discover terms of interest (e.g., “Shows like model”; “Fixer-upper”) that are captured into a term matrix. Terms in the term matrix are scored according to importance, salience, sentiment, and polarity, and ranked on a Likert scale, and then totaled by property. Alternatively, term scores can be inserted in the relevant Likert-ranked feature.

Sample ranges for Feature Adjustment Fractions (FAF(i, j)) are provided below for various features in the exemplar set of 31 features set forth previously herein. One of skill in the art will appreciate that the exact Feature Adjustment Fraction for any given feature in any given valuation will depend on factors including, but not limited to, property location, neighborhood, buyer preferences, and the like.

(4) Bedrooms: 0.0075-0.015;

(5) Bathrooms: 0.01-0.0175;

(6) Flooring: 0.004-0.008;

(7) Fireplace: 0.004-0.007;

(8) Nearby Amenities: 0.00005-0.0001;

(9) Contract Date Adjustment: 0.008-0.0125:

(10) Current Market Conditions: 0.008-0.0125:

(11) Basement features: 0.002-0.005;

(12) Energy: 0.004-0.007;

(13) Property style: 0.015-0.025;

(14) Remodeling: 0.004-0.007;

(15) Exterior finish: 0.01-0.025;

(16) Exterior features: 0.008-0.015;

(17) Parking: 0.008-0.012;

(18) Street traffic: 0.01-0.02;

(19) Gross Living Area (GLA): 0.0001-0.00015;

(20) Basement finished living area: 0.000035-0.00006;

(21) Basement unfinished living area: 0.00002-0.00004;

(22) Lot size: 0.000004-0.000008 if measured in square feet; 0.11-0.15 if measured in acres;

(23) Property age: 0.001-0.0025;

(24) Days on market: 0.02-0.05;

(25) Quality of construction: 0.004-0.007;

(26) Condition: 0.004-0.007;

(27) How well shows: 0.004-0.008;

(28) Site landscaping: 0.004-0.006;

(29) Neighborhood: 0.005-0.01;

(30) School quality: 0.008-0.012; and

(31) Remarks: 0.008-0.012.

As mentioned above, in the embodiment of FIG. 2, the computer-executable instructions at step 201 further carry out the step 210 of valuating and totaling Feature Adjustment Values and the step 212 of valuating the subject by weighing comp adjusted sale prices based on net total adjustments. Totaling all of the Feature Adjustment Values (FAV) for each comp results in a Total Feature Adjustment Value for each comp (TFAV):

TFAV(i)=Σⱼ₌₁^{m}FAV(i,j) (2)
where FAV(i, j) is the feature adjustment value for feature j and comp i (USD); and
TFAV(i) is the Total Feature Adjustment Value for comp i (USD).

This Total Feature Adjustment Value (TFAV) is then added to the Modified Sale Price (MSP) for each comp, thereby producing an Adjusted Sale Price (ASP):

ASP(i)=TFAV(i)+MSP(i) (3)
where TFAV(i) is the Total Feature Adjustment Value of comp I;
   MSP(i) is the Modified Sales Price of comp i; and
   ASP(i) is the Adjusted Sales Price for comp i.

Therefore, the ASP for a given comp is its modified sale price, adjusted for the difference in feature values between the comp and the subject property.

Purely as non-limiting examples, four options can then be used to calculate the final valuation of the subject property, namely (1) a default valuation based on inverse relative weighting of total net feature adjustments (i.e., the smaller the total net feature adjustment, the larger the relative weight assigned), (2) a valuation based on inverse relative weighting of total absolute feature adjustments, (3) a valuation based on the median Adjusted Sale Price, and/or (4) a valuation based on the average (or mean) Adjusted Sale Price. Each of these valuation methods will be addressed in turn. One of skill in the art will appreciate that the accepted practice for licensed appraisers is to select the adjusted comp from the plurality of comps with the smallest total adjustment amount and/or the fewest adjusted features as the valuation for the subject.

First, the default valuation may comprise dividing the Adjusted Sale Price by the Total Net Feature Adjustments, thereby producing a relative weight value for each comp (“Relative Weight”):

RW(i)=ASP(i)/TFA(i) (4)
where RW(i) is the relative weight for comp i.

The Relative Weight for each comp is then totaled, producing a total relative weight value for all comps (“Total Relative Weight”):

TRW=Σᵢ₌₁ⁿRW(i) (5)

Dividing each comp's Relative Weight by the Total Relative Weight produces a fractional weight value for each comp (“Fractional Weight”)

FW(i)=RW(i)/TRW (6)
where FW(i) is the fractional weight of comp i (dimensionless).

The Fractional Weight for each comp is then multiplied by that comp's Adjusted Sale Price. Adding the resulting values for each comp produces a valuation for the subject property:

V=Σᵢ₌₁ⁿ(ASP(i)×FW(i)) (7)
where V=value of subject property (USD).

Second, the valuation based on relative weights may comprise taking the absolute value of each feature adjustment value for each comp. These values are then totaled, producing an absolute value adjustment for each comp (“Total Absolute Value Feature Adjustment”):

TAVFA(i)=Σⱼ₌₁^{m}|FAV(i,j)| (8)
where, TAVFA(i) is the Total Absolute Value Feature Adjustment for comp i (USD).

The Adjusted Sale Price is then divided by the Total Absolute Value Feature Adjustment to produce a Relative Weight for each comp:

RW(i)=ASP(i)/TAVFA(i) (9)

As described in the preceding paragraph, using equation (5) the Relative Weight for each comp (RW(i)) is totaled, producing the Total Relative Weight (TRW). Using equation (6), dividing each comp's Relative Weight (RW(i)) by the Total Relative Weight (TRW) produces a Fractional Weight for each comp (FW(i)). In accordance with equation 7, the products of each comp's fractional weight and adjusted sales price are summed to yield a value for the subject property.

Third, the valuation based on the median Adjusted Sale Price may comprise taking the Adjusted Sale Price from each of the comps (ASP(i)) and calculating a median value. This median value is then used as the valuation for the subject property.

Fourth and finally, the valuation based on calculating the average (or mean) Adjusted Sale Price (ASP(i)) may comprise taking the Adjusted Sale Price from each of the comps and calculating an average (or mean) value. This average value is then used as the valuation for the subject property.

In yet another non-limiting example of calculating a Feature Adjustment Value, the difference in Feature Score between the subject property and each of the comps is calculated, producing a Comp Feature Adjustment Score. For each comp, the Comp Feature Adjustment Score is multiplied by the Feature Adjustment Fraction, as described above herein. This result is then multiplied by the Modified Sale Price for each comp to produce a Feature Adjustment Value in USD.

It should be appreciated that one or more of the above-described steps in method 200 may be executed on one or more computer programs or computer modules comprising sets of computer executable instructions stored on a non-transitory computer executable medium. Such programs or modules may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information stored on a non-transitory medium and conveyed to a computer by a communications medium, such as through a computer or telephone network, including wireless communications.

It should further be appreciated that one or more of the above-described steps in method 200 may be (1) displayed to the user, such as, for example, on a computer screen, on a graphical user interface (GUI), or the like, and/or (2) saved in one or more forms of electronic media storage, such as, for instance, a computer hard drive or computer memory.

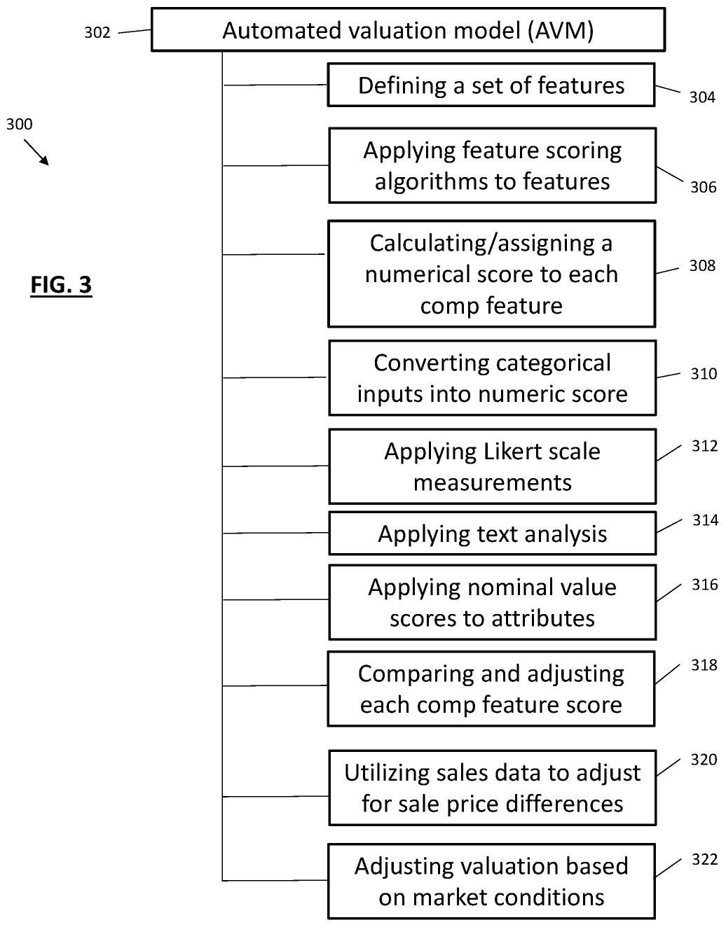

Turning now to FIG. 3, one or more additional embodiments of the present disclosure comprise an automated system 300 for assessing and valuating property, in accordance with one or more implementations of the present disclosure.

The system 300 comprises at least one computer comprising at least one processor operatively connected to at least one non-transitory, computer readable medium, the at least one non-transitory computer readable medium having computer-executable instructions stored thereon, wherein when executed by the at least one processor the computer executable instructions carry out a set of steps defining an automated valuation model 302 for appraising and valuing a subject property, the steps in the set of steps comprising: a step 304 of defining a set of features for the subject property, the set of features comprising a plurality of features of the subject property, for each comparison property in a selected set of comparison properties; a step 306 of applying feature scoring algorithms to one or more features in the set of features; a step 308 of calculating/assigning a numerical feature score to each feature in the set of features, for each comparison property in the selected set of comparison properties; a step 310 of converting categorical inputs for one or more features into a numerical feature score; a step 312 of applying Likert scale measurements to grade subjective judgments for at least some features in the set of features; a step 314 of applying text analysis to a plurality of listings in a multiple listing service, wherein the multiple listing service is a service comprising a database of properties, wherein the database comprises the plurality of listings, and wherein each of the listings in the plurality of listings represents a different property; a step 316 of applying nominal value scores to a plurality of attributes within a feature in the set of features; a step 318 in comparing and adjusting each comp feature score; a step 320 of utilizing sales data to adjust for sale price differences over time between sales of the comparable properties and current market conditions, a step in which the sales price (SPi) for a comp is adjusted to account for a change in value between the date of sale of the comp and the date of the subject property's estimated value, this adjusted sales price being used in all subsequent formulas for comp values that include a sales price; and a step 322 of adjusting valuation of the subject property based on current market conditions by considering factors including average days on market (DOM), average listing price vs. contract price, sale listings, and recent sales of other properties near the subject property.

The set of features for the subject property to be assessed and valuated comprises a plurality of features of the subject property, including, for example, physical characteristics of the property, layout of the property, number of rooms, size of rooms, and the like. One of skill in the art will appreciate that the plurality of features may include some, or all, of the exemplar list of 31 features presented above herein with reference to FIG. 2.

It should be appreciated that the automated valuation model 302, as well as the various steps 304, 306, 308, 310, 312, 314, 316, 318, 320, and 322, in the set of steps, may be part of one or more computer programs or computer modules. Such programs or modules may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information stored on a non-transitory computer readable medium and conveyed to a computer by a communications medium, such as through a computer or telephone network, including wireless communications.

The system 300 may further comprise a dictionary comprising a plurality of real-estate terms used in describing and selling property, and a term matrix capable of isolating commonly-used terms in the plurality of real-estate terms.

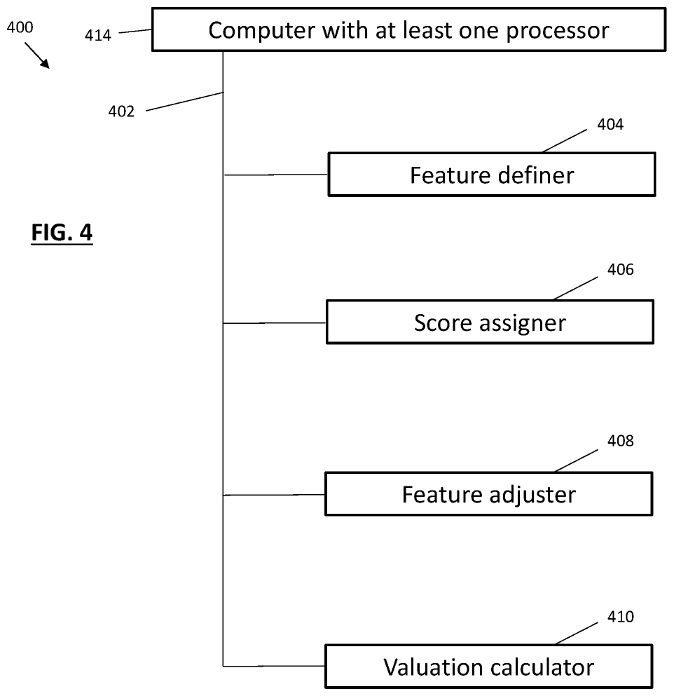

FIG. 4 is a block diagram illustrating an automated system 400 for valuating a subject property, in accordance with one or more implementations of the present disclosure.

The system 400 comprises at least one computer 414 comprising at least one processor, where in the at least one processor is operatively connected to at least one non-transitory, computer readable medium having a plurality of computer executable programs 402 stored thereon, the plurality computer executable programs comprising: a feature definer 404, wherein when executed by the at least one processor, the feature definer defines a set of features for a subject property, the set of features comprising a plurality of features of the subject property; a score assigner 406, wherein when executed by the at least one processor, for each comparison property in a selected set of comparison properties, the score assigner assigns a numerical feature score to each feature in the set of features; a feature adjuster 408, wherein when executed by the at least one processor, for each comparison property in a selected set of comparison properties, the feature adjuster adjusts each feature score to produce a feature adjustment value for the each feature in the set of features; and a valuation calculator 410, wherein when executed by the at least one processor, for each comparison property in a selected set of comparison properties, the valuation calculator valuates the subject property based on the feature adjustment values.

When executed by the at least one processor, the feature definer 404 defines a set of features for a subject property to be assessed and valuated, the set of features comprising a plurality of features of the subject property. The feature definer may be automated and may utilize specific templates that provide for various sets of features and related parameters. The features may include, for example, physical characteristics of the property, layout of the property, number of rooms, size of rooms, and the like. Again, one of skill in the art will appreciate that the plurality of features may include some, or all, of the exemplar list of 31 features presented above herein with reference to FIG. 2.

When executed by the at least one processor, the score assigner 406 assigns, for each comparison property in a selected set of comparison properties, a numerical feature score to each feature in the set of features. It should be appreciated that the score assigner may utilize one or more feature scoring algorithms to execute its one or more function(s), which may be the same, in whole or in part, as the one or more algorithms described above herein with respect to the feature scoring steps of a method for valuating property (e.g., step 206 of FIG. 2).

When executed by the at least one processor, the feature adjuster 408 adjusts, for each comparison property in a selected set of comparison properties, each feature score to produce a feature adjustment value for each feature in the set of features. The feature adjuster may utilize one or more algorithms to execute its one or more function(s), which may be the same, in whole or in part, as the one or more algorithms described above herein with respect to the feature adjustment steps of a method for valuating property (e.g., step 208 of FIG. 2).

When executed by the at least one processor, the valuation calculator 410 valuates, for each comparison property in a selected set of comparison properties, the subject property based on the feature adjustment values. The valuation calculator may utilize one or more of the valuation techniques, such as the FAF, described above herein with reference to FIG. 2.

As mentioned previously, the system 400 further comprises at least one computer 414 for running the plurality of computer executable programs 402 stored on a non-transitory computer executable medium. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information stored on a non-transitory medium and conveyed to a computer by a communications medium, such as through a computer or telephone network, including wireless communications.

Further, one of skill in the art will appreciate that the plurality of computer executable programs 402 may execute its functions, in whole or in part, without the need for a user's instructions. In essence, some or all of the plurality of computer executable programs 402 may be automated with respect to one or more of the feature definer 404, the score assigner 406, the feature adjuster 408, and the valuation calculator 410.

Additionally, in at least one embodiment of the system 400, one or more of the plurality of computer executable programs 402 defines an automated valuation model for appraising and valuing the subject property.

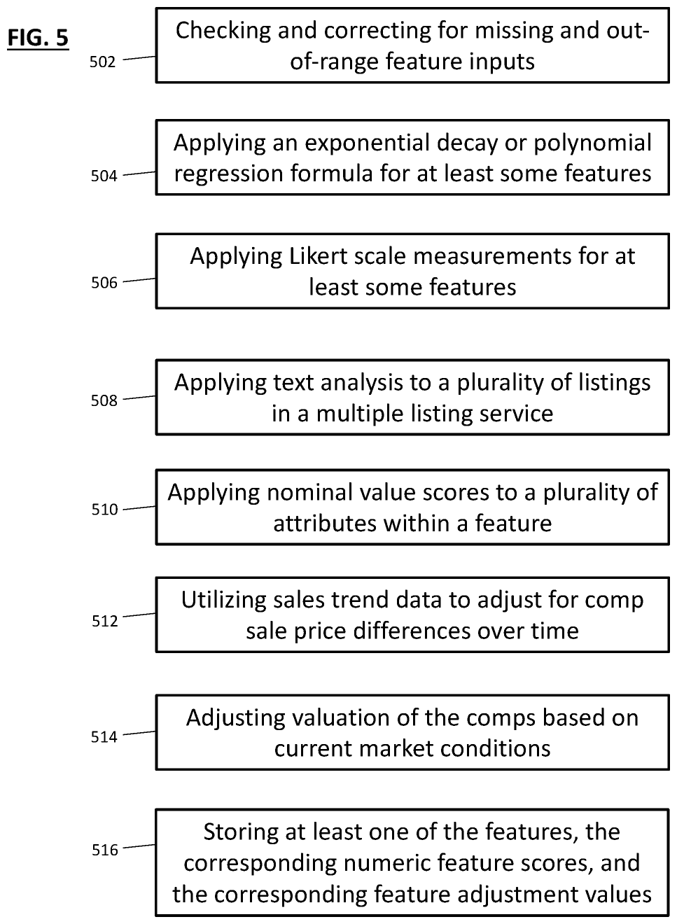

Turning now to FIG. 5, the systems and methods described herein, including one or more of the embodiments described in FIGS. 2-4, may comprise one or more additional steps for assessing and valuating the subject property. FIG. 5 is a block diagram illustrating such potential additional steps, in accordance with one or more implementations of the present disclosure.

Therefore, embodiments of the described systems and methods may also comprise step 502 of checking, and correcting, for missing and/or out-of-range inputs for various features in the selected set of features. These features may include, for example, any one or more of the 31 exemplar features described above herein with reference to FIG. 2.

Embodiments of the described systems and methods may further comprise step 504 of applying an exponential decay or polynomial regression formula to calculate value for at least some features in the set of features. Purely as a non-limiting example, in situations where the subject property is a real estate property, the exponential decay formula may be used in valuing the marginal utility of additional area, as well as in calculating depreciation and/or functional obsolescence based on age of the house or dwelling located on the property.

Embodiments of the described systems and methods may additionally comprise step 506 of applying Likert scale measurements to grade subjective judgments for at least some features in the selected set of features, thereby transforming such subjective judgments into objective scores.

Embodiments of the described systems and methods may additionally comprise step 508 of applying text analysis to a plurality of listings in a multiple listing service, wherein the multiple listing service is a service comprising a database of properties, wherein the database comprises the plurality of listings, and wherein each of the listings in the plurality of listings represents a different comparison property from among the plurality of comparison properties. It should be appreciated that such application of text analysis may improve and optimize feature scores, adjusted monetary values, and overall adjusted sales prices.

Embodiments of the described systems and methods may additionally comprise step 510 of applying nominal value scores to a plurality of attributes within at least one feature in the selected set of features, thereby insuring consistent consideration of differences within the feature.

Embodiments of the described systems and methods may additionally comprise step 512 of utilizing sales data to adjust for sale price differences over time between sales of at least one of the comparison properties and current price trends. In this step, the sales price (SPi) for a given comp is adjusted to account for a change in value between the date of sale of the comp and the date of the subject property's estimated value. This adjusted sales price is then used in all subsequent formulas for comp values that include a sales price.

Further, at least one embodiment comprises a step 514 of adjusting the valuation of the subject property based on current market conditions by considering average days on market (DOM), average listing price vs. contract price, sale listings, and recent sales of other properties near the subject property.

Embodiments of the described systems and methods may additionally comprise step 516 of storing at least one of the features from the selected set of features, and the numeric feature scores corresponding to the selected set of features. Storage may be in physical or electronic media, and either temporary or permanent in nature.

One of skill in the art will appreciate that one or more of the steps illustrated in FIG. 5 may utilize one or more algorithms as described previously herein. Further, one or more of the steps illustrated in FIG. 5 may be part of one or more computer programs or computer modules comprising a set of computer executable instructions stored on a non-transitory computer readable medium. Such programs or modules may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information stored on a non-transitory computer readable medium and conveyed to a computer by a communications medium, such as through a computer or telephone network, including wireless communications.

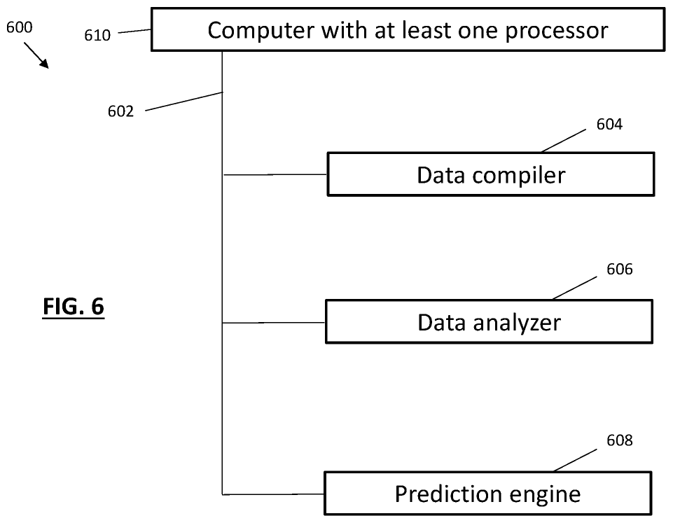

Turning now to FIG. 6, one or more additional embodiments of the present disclosure comprise a system 600 for predicting value of one or more items.

The system 600 comprises at least one computer 610 comprising at least one processor, where in the at least one processor is operatively connected to at least one non-transitory, computer readable medium having a plurality of computer executable programs 602 stored thereon, the plurality of computer executable programs comprising: a data compiler 604, wherein when executed by the at least one processor, the data compiler compiles data from one or more past sales, and the one or more past sales are of items belonging to a same category as that of one or more items to be valuated; a data analyzer 606, wherein when executed by the at least one processor, the data analyzer analyzes the one or more past sales; and a prediction engine 608, wherein when executed by the at least one processor, the prediction engine predicts a value of the one or more items to be valuated based on the analyzed data from the one or more past sales.

The data compiler 604 is capable of compiling data from past sales of one or more categories of items, such as, for example personal items, luxury goods, vehicles, and the like. Such data may be obtained from sources, such as, for instance, publicly available databases, private auction listings, appraisals, and the like. The data compiler may then extract relevant information on each sale, including, for example, the date of sale, the condition of the item, the date the item was made, and the date the item was first sold. One of skill in the art will appreciate that the specific category, or categories, of items that are of interest to the user depends on the category of the item to be valuated or appraised. Purely as a limiting example, if the item to be appraised is a boat, then a user may wish to restrict it so that the data compiler 604 only collects data about sales of boats, or, even more specifically, sales of specific types of boats.

The data analyzer 606 is capable of analyzing the various data associated with the past sales collected and organized by the data compiler 604. It should be appreciated that such data may include the relevant information referenced in the immediately preceding paragraph, including, for example, the sale price, the date of sale, the condition of the item, the date the item was made, and the date the item was first sold. The data analyzer then executes one or more steps to help determine the appraisal value of the item, including, for instance, any of the steps described herein with respect to embodiments for a method of valuating property.

Either one or more of the data compiler 604 and the data analyzer 606 are further capable of extracting the same categories of relevant information about the specific item to be valuated or appraised, in order that such information may be directly compared between the item to be appraised and the past sales of other items in the same category.

The prediction engine 608 is capable of predicting the appraisal value of the item to be valuated based on the relevant information extracted from past sales of items of the same, or similar, category. Purely as a limiting example, the prediction engine may utilize the sale amounts from past sales of similar items to construct a predictive mathematical analysis as to how well the item to be appraised will sell. An appraisal or valuation value can then be set based on these past sales.

As described above, the system 600 further comprises a computing system 610 for running the plurality of computer executable programs 602, which may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive, solid state storage devices); and (iii) information stored on non-transitory computer readable medium and conveyed to a computer by a communications medium, such as through a computer or telephone network, including wireless communications.

It should be appreciated that one or more of the data compiler 604, the data analyzer 606, and the prediction engine 608 may utilize one or more algorithms. In some instances, the same algorithm or algorithms may be used by one or more of the data compiler, the data analyzer, and the prediction engine. It should also be appreciated the plurality of computer executable programs 602 may execute its functions, in whole or in part, without the need for a user's inputs or instructions. In essence, some or all of the plurality of computer programs 602 may be automated with respect to one or more of the data compiler 604, the data analyzer 606, and the prediction engine 608.

Indeed, each of the steps, processes, methods, and/or algorithms described herein may be embodied in, and fully or partially automated by, code instructions executed by one or more computer systems or computer processors comprising computer hardware. The processes and algorithms may be implemented partially or wholly in application-specific circuitry.

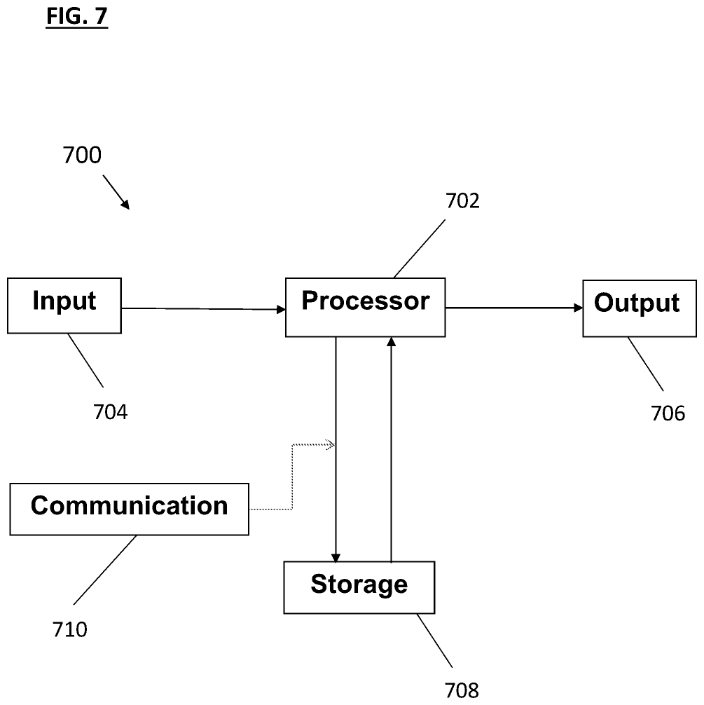

Turning now to FIG. 7, an exemplary computer system 700 is shown that is configured to execute one or more of the steps, processes, methods, and/or algorithms described above herein from data inputs selected from a database storage device. The system 700 comprises one or more computer processors 702, one or more inputs 704, one or more outputs 706, and one or more storage media 708, and one or more communication links/networks 710. The one or more processors 702 may comprise various computer hardware and/or software components, including, for instance, computer processing units (CPUs), arithmetic/logic units, control units, software operating systems, and software applications. The one or more inputs 704 enable a user to communicate with the one or more processors, and can comprise input devices such as, for example, a keyboard, a mouse, a touch pad, a touch screen, and the like. The one or more processors 702 then executes one or more of the processes, methods, and algorithms described herein, communicating with the one or more outputs 706. These outputs can comprise output devices such as, for instance, a computer monitor, a computer screen display, a computer printer, a computer speaker, and the like. Additionally, the one or more processors 702 can both send information to, and recall information from, one more storage media 708. The storage media can comprise both storage devices, such as, for instance, a physical server, internal and external hard drives, flash or USB drives, compact discs (CDs), and memory cards, a virtual server (including a cloud storage server), as well as software components, such as, for example, a database, a database management system, and data within a database. One or more communications 710 can also be sent from the processor 702 to the storage 708.

One or more additional embodiments of the present disclosure relate to the following methods and systems for valuating property, including, for instance, a subject property. Such one or more embodiments can be used in a variety of situations, including, for example, setting pricing for properties to be listed for sale; appraising properties under consideration for purchase; appraising properties for mortgage and bank company refinancing; appraising properties for insurance purposes; setting pricing for properties to be rented; assessing properties under consideration for rental; appraising properties for financial planning and personal interest purposes; appraising properties for renovation and resale (flipping), and selecting properties that provide the best value to a specific buyer based on their preferences, characteristics, and constraints.

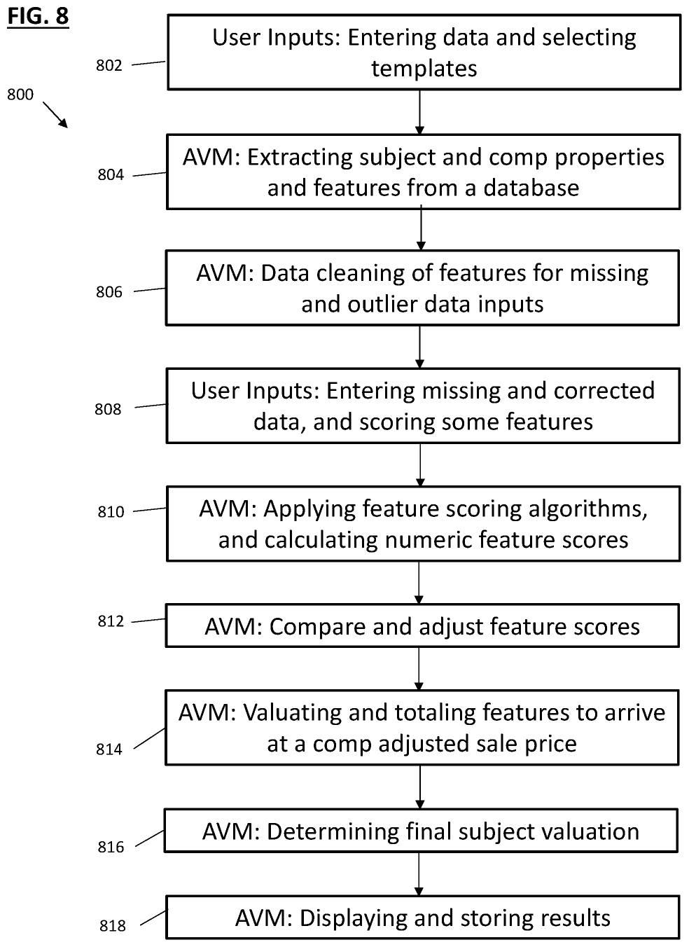

FIG. 8 is a block diagram that illustrates various actions 800 that may be taken by a user and/or an automated valuation model (AVM), which may be, for instance, the AVM described above in FIG. 3. First, the user may, at step 802, input data such as the subject property into the AVM and select templates for selecting potential comps and for valuating the subject property. Then, at step 804, the AVM extracts information on both the subject and potential comp properties, as well as the set of features to be used for comparison, from one or more databases, including, for instance, a multiple listing service database. At step 806, the model then performs data cleaning of feature data to resolve missing and/or outlier data inputs. At step 808, the user may enter and/or correct any missing and/or inaccurate data, as well as enter any feature scores. The AVM then applies one or more feature scoring algorithms, followed by calculating/assigning a numeric feature score to each feature in the set of features at step 810. The model subsequently compares and adjusts the feature scores at step 812, valuates and totals the feature adjustments to arrive at a comp adjusted sale price at step 814, followed by weighting the total net adjustments for each comp to arrive at a final subject valuation at step 816. Finally, at step 818, the AVM displays the final valuation of the subject property and stores any results and feature data.

At least one of the aforementioned one or more additional embodiments comprises three sequential automated processes:

(1) Select Comps: Identify and select the most similar and relevant comparable properties (comps) to the subject property from a universe of properties;

(2) Compare and Adjust Features: Evaluate, compare, and adjust for differences in features between the subject property and the selected comps; and

(3) Determine the Subject Valuation: Valuate the feature adjustments and then total the modified sale price and feature-valued adjustments for each comp, and finally weight each comp according to the total adjustment value to arrive at the best estimate of market value for the subject property.

The at least one embodiment may additionally comprise a set of computer-executable instructions stored on one or more non-transitory computer readable media, wherein when executed by at least one processor, the computer-executable instructions carry out the following steps:

(1) Finding, filtering, and selecting comp properties most similar to the subject property from the universe of comps;

(2) Defining and selecting a set of features for the subject and comps;

(3) Applying a feature scoring algorithm corresponding to a feature of the same type to calculate a numeric feature score for each feature in the selected set of features for the subject property and each comparison property in the selected set of comparison properties;

(4) Comparing each feature score of the subject to each corresponding comp to arrive at a set of feature difference scores for each comp;

(5) Valuing each comp feature adjustment by multiplying the corresponding feature difference score times Feature Adjustment Factor (which normalizes and weights features) times the Comp Modified Sale Price (scales and monetizes features) thereby producing a set of Feature Adjustment Values valued in dollars for each comp in the set of feature adjustment values corresponding to a selected feature in the set of features and a comparison property from among the set of comparison properties;

(6) Totaling all feature adjustment values and Comp Modified Sale Price for each comp to yield an estimated subject valuation for each adjusted comp, a Comp Adjusted Sale Price; and

(7) Weighing the extent of adjustments made to each Comp Adjusted Sale Price to yield the subject property estimated valuation.

The aforementioned Select Comps process comprises identifying, scoring, and selecting the most similar and the most relevant comparable properties to the subject property. Then, the Compare and Adjust Features process comprises evaluating both the subject property and the comps to determine which features each property has, and then comparing these features and adjusting for differences between these features. Then, the Determine the Subject Valuation process comprises valuing the comps and arriving at the best estimate of market value for the subject property.

With respect to the Select Comps process, it should be appreciated that an important step in any valuation process, including the SCA, is to select the best set of comps as possible to compare with the subject property, since such comps help generate a reliable estimate of market value for the subject property. In other words, comparing more dissimilar comps generally leads to less accurate valuations.

The Select Comps process comprises primarily two steps:

(A) Eliminate dissimilar and outlier properties from the universe of available comps based on, for instance, Transaction Type (e.g., only select potential comps that are arms-length market sales); Property Type (e.g., only select potential comps that the same type as the subject); Location Proximity (e.g., for suburban locations, only select potential comps within 1 mile of the subject property); and Time Proximity (e.g., only select potential comps with sale dates within 180 days of the current analysis date), and

(B) Find the most similar comps to the subject by comparing the Gross Living Area (GLA) and Sale Price of the subject (imputed) with each of the potential comps (modified).

To do the above-mentioned comparison in (B), an individual can use, as a non-limiting example, the following sub-steps:

(1) Determine the Absolute % Difference between the subject GLA and each of the potential comp GLAs;

(2) Find the five closest Comp Gross Living Areas (GLA) to the Subject GLA;

(3) Average the Comp Modified Sale Prices for those five closest comps, and assign that price as the Subject Imputed Sale Price;

(4) Determine the Absolute % Difference between the Subject Imputed Sale Price and each of the potential comp Modified Sale Prices;

(5) Sum the Absolute Percent Differences in GLA and Sale Price into a Combined Percent Difference for each comp;

(6) Filter out any comps that are more than 20% of the Combined Percent Difference to prevent comparison of properties that are too dissimilar; and

(7) Select up to seven of the remaining most similar comps as the set of comps for further processing.

Such steps ensure that the most similar comps to the subject property are chosen for further analysis.

After the Select Comps process is completed, the next process is to Compare and Adjust Features, in which the comp features are adjusted for the differences between the subject property and each comp. This can be done as follows:

(1) A feature set is selected for the subject and all comps. A non-limiting example of a default feature set for valuating residential real estate comprises the 31 features described above herein. It should be appreciated that the source for many feature entries is one or more databases, e.g., a multiple listings service database. Such database entries are generally defined as having one of the following data types: continuous numeric, ranked numeric, categorical symbolic keyword(s), text (unstructured and semi-structured data) such as a remarks data field, and special types such as date and address.

(2) Feature scoring can then be done, which converts raw feature entries (data types) into numerically scored features by employing feature scoring algorithms depending on the feature type and data type. For some features, the feature scoring algorithm converts the raw entry into a numeric feature score. For various other features, such as bedrooms, bathrooms, and fireplaces, no conversion is necessary as the raw entry is the feature score. Some numeric raw feature inputs require a feature scoring algorithm, such as exponential decay, to convert the raw score into a more accurate score for subsequent feature valuation.

(3) Comparing and adjusting comp features can then be done. This involves calculating the feature difference scores between the subject and each comp for each feature.

(4) Finally, conversion of each feature difference score into a feature difference value can be done. Each feature difference is valued in terms of the modified sale price. This ensures that all feature differences are monetized and scaled properly in the context of the neighborhood and property in which they occur, in contrast to common practice by licensed appraisers. For instance, such common practice involves valuing the difference in GLA between the subject and a given comp at $40-$50/SF for metropolitan areas, despite the fact that differing neighborhoods may vary greatly in their average modified sale price, ranging from, e.g., $40/SF to $400/SF. In addition, each feature difference is weighted in terms of relative importance of that feature and normalized by application of a Feature Adjustment Fraction (FAF). When the feature valuation formula is applied, a feature adjustment score is multiplied by the FAF and by the comp modified sale price, and the result is a feature adjustment value that is valued in dollars.

The Compare and Adjust Features process comprises both a Feature Scoring step and a Feature Adjustment step, both of which use features of the subject property. Such features can be drawn from the following non-exhaustive list:

(1) Sale Price;

(2) Concessions;

(3) Modified Sale Price (calculated by subtracting the concessions value from the sale price value);

(4) Bedrooms;

(5) Bathrooms;

(6) Flooring;

(7) Fireplace;

(8) Nearby Amenities (e.g., availability of nearby recreation, parks, shopping, stores, restaurants, and medical facilities);

(9) Contract Date Adjustment (e.g., scoring in % change in local prices in the relevant metro area or zip code over time difference between the Contract Date and Analysis Date in days/30; in months from available sources);

(10) Current Market Conditions (e.g., scoring includes various factors, such as, for example, average days on market (DOM), average listing price vs. contract price, sale price trends; seasonality; inventory (supply listed for sale in months); demand (sales for the last month, adjusted year over year); average sale price (adjusted year over year); percent of Real Estate Owned by Banks (REO); percent short sales; and percent rentals);

(11) Basement features;

(12) Energy;

(13) Property Style (i.e., differences in house styles, such as, for example, colonial, Victorian, contemporary, ranch, split-level, etc.);

(14) Remodeling;

(15) Exterior Finish (e.g., stone, brick, siding, shingle, stucco, etc.);

(16) Exterior features (e.g., decks, porches, patios, balconies, outdoor cooking stations, fences, sheds, outbuildings, etc.);

(17) Parking (e.g., one-car garage, two-car garage, carport, urban off-street parking, parking lot, street parking, etc.);

(18) Street Traffic (e.g., cul-de-sac=2; average street=0; difficult street parking=−2; busy street=−3; highway=−6);

(19) Gross Living Area (GLA);

(20) Basement Finished Living Area;

(21) Basement Unfinished Living Area;

(22) Lot Size (in fraction of an acre or square feet);

(23) Property Age;

(24) Days on Market (DOM) (i.e., the length of time in days that the property was listed for sale prior to contract).

(25) Quality of Construction;

(26) Condition (e.g., based on inspection and text analysis and text mining of remarks in a property's listing in a multiple listing service);

(27) How Well Shows (i.e., how well the property shows to potential buyers, which takes into account furnishings, décor including wall colors, neatness, and cleanliness);

(28) Site Landscaping;

(29) Neighborhood (e.g., community amenities, views, nuisances, and general condition of neighborhood);

(30) School Quality (e.g., information obtained from the Great Schools website, scored on 1-10 scale); and

(31) Remarks (e.g., textual data and/or remarks from one or more databases, such as, for instance, terms like “Shows like model,” “Fixer-upper,” etc.).

The Feature Scoring process can apply, for instance, Feature Scoring Algorithms that convert feature entries for several types of features into numeric feature scores. These algorithms include, but are not limited to: Raw Score, Feature Classification, Multiple Attributes, Likert Scale, Exponential Decay, Text Analysis/Text Mining, and Contract Date Adjustment.

With respect to Raw Score, some features (such as Bedroom and Bathroom) utilize a raw numeric score from data obtained from a multiple listing service, and do not require a Feature Scoring Algorithm. Thus, “1” is entered in place of the Feature Scoring Algorithm.

With respect to Feature Classification, several features have categorical symbolic terms as data inputs (such as House Style and Exterior Finish) that can then be classified into a numeric score reflective of their general market desirability.

With respect to Multiple Attributes, several features (such as Basement Features and Exterior Features) present as multiple aspects and/or attributes of a feature with categorical symbolic terms that require classification into numeric scores for each attribute that are then totaled into a composite feature score that reflects the various aspects and/or attributes of that feature.

With respect to Likert Scale, some features requiring manual entry are more subjective and are converted to and scored on a numeric ranking scale. For consistency with existing appraisal scoring methods, several features (e.g., Quality of Construction, Condition, How Well Shows, Site Landscaping, and Neighborhood) use a qualitative Likert Scale, with best=1 and worst=7, that quantifies subjective judgments. For these features, the Feature Adjustment Score is the simply the difference between the Likert Scores for the specific comp and the subject property, except that the scoring difference is reversed.

With respect to Exponential Decay, features involving the measurement of area or age apply an exponential decay formula. Use of exponential decay for features measuring area reflects the declining economic marginal utility of additional area and the reduced value of more units of that feature. Use of exponential decay for the Property Age feature reflects the depreciation and/or functional obsolescence and declining economic functional value of that property. Use of exponential decay for the Days on Market reflects the declining marginal significance of more time units for that feature. The exponential decay factor, slightly less than 1, is raised to the power of the score of the feature, in square feet or age. The resulting decay factor is multiplied by the feature score, yielding the discounted, marginal value of each score. The smaller the range of feature scores, the larger the decay factor that is used, and the faster the decay occurs. Features dealing with area include, but are not limited to, Gross Living Area, Basement Finished Area, Basement Unfinished Area, and Lot Size. Features dealing with age include, but are not limited to, Property Age and Days on Market.

In at least one embodiment, polynomial regression formulae are used as an alternative to exponential decay formulae. Such polynomial regression formulae may be preferable in order to provide a better fit for feature entries that have more irregular, non-Gaussian data sets, as well as for feature entries where more detailed scoring is desired to represent local variations.

With respect to Text Analysis/Text Mining, it should be appreciated that free text (also known as “unstructured data”) from databases (e.g., a multiple listings service database), realtor sales data, appraisals, and similar sources can be matched to terms in a predetermined term database, analyzed manually, or analyzed by text analysis and/or text mining software to discover terms of interest (e.g., “Shows like model”; “Fixer-upper”). These terms can then be captured into a term matrix, and can be scored according to importance, salience, sentiment, and polarity, and ranked on a Likert scale, and then totaled by property. Alternatively, term scores can be inserted into the relevant Likert-ranked or multi-attribute features. These tools can also analyze categorical symbolic terms that may be present as separate data fields, such as Property Style, in a multiple listings service database. Further, these tools would find additional adjustments not detected elsewhere, that, once discovered, would be subsequently applied to all valuations. Finally, trigrams are employed to check for alternate spellings and minor misspellings.

With respect to External Sources, several features (such as, for instance, School Quality and Current Market Condition) rely on external sources of data for calculation.

Additional features may be present with categorical symbolic term(s) that are classified into assigned numeric scores reflective of general market desirability, including, but not limited to, the following:

(13) Property Style (i.e., differences in house styles, such as, for example, scores for the mid-Atlantic region: colonial=3; craftsman=3; Victorian=3; special/historical=4; bungalow=3; art deco=1; contemporary=1; cape cod=1; traditional=1; rambler=0; split level=−0.5; split foyer=−1; ramshackle=−2);

(14) Exterior Finish with scores for mid-Atlantic region: (e.g., stone=1.5; brick=1; shingle=1; mix brick/siding=0.5; smooth/stucco=0.5; siding=0);

(15) Remodeling (e.g., new=10; major remodel=5; minor remodel=2; master suite=1; large kitchen with island=1; or alternatively, 60% of the remodeling cost entered directly without applying FAF as percent (%) of Modified Sale Price); and

(24) Street traffic (e.g., cul-de-sac=2; average street=0; busy street=−3; highway=−6).

Additional features have multiple aspects that are awarded scores, which are then totaled into an overall numeric feature score, including, but not limited to, the following:

(9) Basement Features (e.g., walk-out=1.5; windows=1; outside entry=1; bedroom=1; bathroom=1; recreation room=1; kitchen=1.5; wine cellar=1; theater=1.5; sump pump=−2);

(12) Energy Efficiency (e.g., scoring for heating: natural gas=2; radiators=1.5; baseboard=1; oil/propane=−2; heat pump=−4; electric resistance=−8, scoring for cooling: Central Air Conditioning (CAC)=0; CAC Scroll Energy Efficiency Rating (EER) 16+=2; multi-zone systems=1; window AC=−3; no AC=−10; ceiling fan=0.5; heat pump=−2, further scoring for energy efficiency: super insulation=+5; sub-standard insulation=−5; single-glazed windows=−5; solar photovoltaic panels=+4);

(15) Remodeling (e.g., new=10; major remodel=5; minor remodel=2; master suite=1; large kitchen with island=1; or alternatively, 60% of the remodeling cost entered directly without applying FAF as percent (%) of Modified Sale Price);

(21) Exterior Features (e.g., porch=1.5, deck=1, balcony=0.5, patio=1, fence=0.75, shed=0.5, workshop=1.5, gazebo=1, permanent outdoor cooking and eating station=0.75, pool=4, heated pool=1; and

(23) Parking (e.g., one-car garage=1; two-car garage=2; carport=0.5; one-car off-street parking=0.3; street parking=0; distant parking lot=−1; difficult street parking=−2).

An exponential decay formula may be applied to further features that involve area in order to properly calculate marginal utility, or age in order to properly calculate functional depreciation or declining importance over time. Such features include, but are not limited to:

(4) Gross Living Area (GLA);

(7) Basement Finished Living Area;

(8) Basement Unfinished Living Area;

(16) Property Age;

(20) Lot Size (in acres or square footage); and

(29) Days on Market (DOM) (i.e., the age of the property listing).

Some features, such as, for instance, the following features, are subjective and are measured on a numeric ranking or Likert scale with a rating of 1 to 7:

(17) Quality of Construction (i.e., based on inspection);

(18) Condition (e.g., based on inspection and Text Analysis/Text Mining of remarks in a property's listing in a multiple listing service);

(19) How Well Shows (i.e., how well the property shows to potential buyers including furnishings, décor including wall colors, neatness, and cleanliness);

(22) Site Landscaping;

(26) Neighborhood (e.g., consider community amenities, views, nuisances, and general condition of neighborhood);

(27) Nearby Amenities (e.g., availability of nearby recreation, parks, shopping, stores, restaurants, and medical facilities);

(28) School Quality (e.g., scored on a 1-10 scale with 10 as best from greatschools.com); and

(31) Current Market Conditions (the scoring of which includes, e.g., average days on market (DOM), average listing price vs. contract price, sale price trends, seasonality, inventory/supply (houses listed for sale (in days)); demand (sales for last month, adjusted year over year); housing average sale prices (adjusted year over year); percent Real Estate Owned by Banks (REO); percent short sales; percent rentals.

Some features, such as, for instance, the following feature, update the comp sale prices from the time of the contract to the analysis date to account for changes in local market trends:

(30) Contract Date Adjustment (e.g., scoring in percent change to comp sale prices from local prices in metro area or zip code over time difference between Contract Date and Analysis Date, in months from available sources).

In the Feature Adjustment step, each Comp Feature Score is compared with the Subject, and adjusted to produce a Feature Adjustment Score for each feature for each comp. The calculation of such Feature Adjustment Scores maybe achieved, for example, via the sub-steps set forth above herein.

Sample Feature Value Formulas fj(NFS(i,j) are provided below for various features:

(4) Gross Living Area (GLA) (in SF)=(GLA of the subject property)*(decay factor (1−0.0006) raised to the power of (GLA of the subject property))−(GLA of the comp)*(decay factor (1−0.0006) raised to the power of (GLA of the comp property)), with an exponential decay range of between 0.0004 to 0.0007. As a non-limiting example, a subject property located in Northern Virginia has a GLA of 1,106 SF, while a relevant comp has a GLA of 1,296. The GLA decay factor would accordingly be (1−0.0006)=0.9994. The GLA Difference=1,106*0.9994^{(1,106)}−1,296*0.9994^{(1,296)}=−164 SF.

(5) Bedrooms=number of bedrooms of the subject property−number of bedrooms of the comp.

(6) Bathrooms=number of bathrooms (including half-bathrooms) of the subject property−number of bathrooms (including half-bathrooms) of the comp.

(7) Basement Finished Living Area=(Subject Basement Finished Living Area)*(decay factor (1−0.0006) raised to the power of (Subject Basement Finished Living Area))−(Comp Basement Finished Living Area)*(decay factor (1−0.0006) raised to the power of (Comp Basement Finished Living Area)), with an exponential decay range of between 0.0004 to 0.0007.

(8) Basement Unfinished Living Area=(Subject Basement Unfinished Living Area)*(decay factor (1−0.0006) raised to the power of (Subject Basement Unfinished Living Area))−(Comp Basement Unfinished Living Area)*(decay factor (1−0.0006) raised to the power of (Comp Basement Unfinished Living Area)), with an exponential decay range of between 0.0004 to 0.0007.

(9) Basement Features=basement feature score of the subject property−basement feature score of the comp. The basement feature score scale is as follows: walkout basement=1.5, outside entrance=1, recreation room=1; bedroom present=0.5, bathroom present=1, kitchen present=1.5, wine cellar=1, home theater=1.5, sump pump=−2. One of skill in the art will appreciate that any given basement may have one or more of these variations, for which the basement score will be the sum of all the variations present.

(10) Flooring=flooring score of the subject property−flooring score of the comp. The flooring score scale is as follows: wood=2, tile=1, carpet=0.

(11) Fireplace=number of fireplaces of the subject property−number of fireplaces of the comp.

(12) Energy=energy score of the subject property−energy score of the comp. The energy score is the sum of the heating score, the cooling score, and the energy efficiency score. The heating score scale is as follows: natural gas=2, radiators=1.5, baseboard=1, oil/propane=−2, heat pump=−4, electric resistance=−8. The cooling score scale is as follows: central air conditioning (CAC)=0, CAC with Scroll energy efficiency rating (EER) 16+=2, multi-zone system=1, window air conditioning=−3, no air conditioning=−10. The energy efficiency score scale is as follows: super insulation=5, sub-standard insulation=−5, single-glazed windows=−5, solar photovoltaic panels=4.

(13) Property Style=style score of the subject−style score of the comp. The style score scale is as follows for the Eastern United States: colonial=3, craftsman=3, bungalow=3, special/historic=4, deco=1, contemporary=1, Cape Cod=1, rambler=0, split level=−0.5, split foyer=−1, ramshackle=−2.

(14) Exterior Finish=exterior finish score of the subject property−exterior finish score of the comp. The exterior finish score scale is as follows: stone=1.5, brick=1, shingles=1, mixed brick/siding=0.5, smooth/stucco=0.5, siding=0.

(15) Remodeling=remodeling score of the subject property−remodeling score of the comp. The remodeling score scale is as follows: major remodeling=5, minor remodeling=2, master suite present=1, large kitchen with island present=1. Alternatively, the remodeling score can be set at 60% of the remodeling cost.

(16) Property Age (PA)=current year−year built. The PA Difference=(Comp PA Score)*(decay factor (1−0.006) raised to the power of (Comp PA Score))−(Subject PA Score)*(decay factor (1−0.006) raised to the power of (Subject PA Score)), with an exponential decay range of between 0.005 to 0.007. If a PA is blank, “0” is entered.

(17) Quality of Construction=construction quality score of the comp−construction quality score of the subject property. The construction quality score scale is a Likert scale from 1 (best quality) to 7 (worst quality), with 4 being average quality. Additionally, a new house is rated as −5.

(18) Condition=condition of the comp−condition of the subject property. The condition score scale is a Likert scale from 1 (best condition) to 7 (worst condition), with 4 being average condition. Additionally, a new house is rated as −10.

(19) How Well Shows=score of how well the comp shows−score of how well the subject property shows. The “how well shows” score scale is a Likert scale from 1 (best showing) to 7 (worst showing), with 4 being average showing. Additionally, staging is rated as −5.

(20) Lot Size (in square feet [SF] or acre fraction). If Lot Size is in acre fraction, then the Lot Size in SF=acre fraction*43,560. The Lot Size Difference=(Subject Lot Size SF)*(decay factor (1−0.000003) raised to the power of (Subject Lot Size SF))−(Comp Lot Size SF)*(decay factor (1−0.000003) raised to the power of (Lot Size SF)), with an exponential decay range of between 0.000002 to 0.000004.

(21) Exterior Features=exterior features total score of the subject property−exterior features total score of the comp. This feature is represented by the summed scoring of attributes present within a feature. The exterior attributes score scale is as follows: porch=1.5, deck=1, balcony=0.5, patio=1, fence=0.75, shed=0.5, workshop=1.5, gazebo=1, permanent outdoor cooking and eating station=0.75, pool=4, heated pool=1.

(22) Site Landscaping=site landscaping score of the comp−site landscaping score of the subject property. The site landscaping score scale is a Likert scale from 1 (best landscaping) to 7 (worst landscaping), with 4 being average landscaping.

(23) Parking=parking score of the subject property−parking score of the comp. The parking score scale is as follows: two-car garage=2, one-car garage=1, carport=0.5, off-street parking=0.3.

(24) Street Traffic=traffic score of the subject property−traffic score of the comp. The traffic score scale is as follows: located in a cul-de-sac=2, located on an average street=0, located on a street with difficult parking=−2, located on a busy street=−3, located near a highway=−6.

(25) Remarks=One or more terms that are scored on a 1-7 Likert scale and then totaled by property, and/or adjustments are scored and entered under the relevant feature.

(26) Neighborhood=neighborhood score of the comp−neighborhood score of the subject property. The neighborhood score scale is a Likert scale from 1 (best neighborhood) to 7 (worst neighborhood), with 4 being an average neighborhood.

(27) Nearby Amenities=Nearby Amenities score of the subject property−Nearby Amenities score of the comp.

(28) School Quality=school quality score of the subject property−school quality score of the comp. The school quality score scale is from 1-10, based on the scores given by the Great Schools website, available at https://www.greatschools.org/.

(29) Days on Market (DOM)=sale or contract date of the comp−listing date of the comp. Since the “days on market” value for the subject property is unknown, the average (mean) of the “days on market” score for all comps, or all nearby property listings may be used. Comps with a DOM less than the average DOM score are assumed to sell slightly under market value, and comps with a DOM more than the average score are assumed to sell slightly over the market value. This is accomplished by using exponential decay with the zero center point as the average score of nearby comps. Properties that sell in 1-5 days are assumed to be underpriced by up to 5%. The DOM Difference=(Avg DOM Score)*(decay factor (1−0.003) raised to the power of (Avg DOM Score))−(Comp DOM Score)*(decay factor (1−0.003) raised to the power of (Comp DOM Score)), with an exponential decay range of between 0.002 to 0.004. If a DOM is blank, “0” is entered.

The Feature Adjustment Fraction (FAF) takes a dimensionless numeric feature adjustment score as input and converts it into a value by normalizing and weighing the relative importance of the feature when multiplied by the FAF, and by scaling and monetizing the feature when multiplied by the comp modified sale price. When a feature adjustment score is multiplied by the FAF and by the comp modified sale price, the result is a feature adjustment value that is valued in dollars.

It should be appreciated that data quality and data cleaning techniques may also be used. Such techniques can identify, and resolve, missing or out-of-range feature values, thereby ensuring that data are accurate, that data values are repaired when needed, and that data values generated when missing. Text cleaning techniques can also clarify and improve the meaning of text data, such as data relating to the Remarks feature. It should also be appreciated that, if no feature value exists for a given feature, that feature can be ignored in the valuation process.

Various methods for data cleaning may be used, such as, for instance:

(1) Elicit knowledge, opinions, and worked examples from domain experts in data quality, real estate agents, mortgage companies, and appraisers.

(2) If, for instance, a given feature value is missing or out of range, an alternate feature value may be provided by, for example, other databases, records, or individual inquiry and/or observation. A default feature value may also be entered.

(3) If no such default value exists, the median value for the feature from the other comps can be used, at least for features that have numeric and cardinal feature values.

(4) Alternatively, for missing data, a comparison can be done of the accuracy of alternative approaches such as average or median of comps with or without the subject, or the value of a similar feature for the same property, to provide substitute values.

Additionally, embodiments of the present disclosure may also make adjustments for changing and current market conditions by considering local data for housing, economy, and employment such as average days on market (DOM), average listing price vs. contract price, sale price trends, seasonality, current inventory of listings, number of sales within the last 30 days, current number of properties under contract, residential vacancy rates, mortgage rates, and local unemployment rates.

The following examples further illustrate one or more embodiments of the present disclosure, but should not be construed as limiting the present disclosure, which is defined by the claims.

### Example 1

This example relates to the selection of a plurality of comps for a subject property and more specifically to the filtering of potential comps into a set of similar comps. Comp selection, as described above herein, is employed to filter out dissimilar comps and to select a small set of the most similar and relevant comps to the subject property for subsequent valuation.

The subject property in the example below is a specific single-family detached residence in Woodbridge, Va., near Alexandria and Washington, D.C. (“Woodbridge Property”). The Woodbridge Property has a GLA of 1,106 square feet and an undetermined sale price.

For this property, 11 potential comps (named Comps 1-11) were generated and filtered from the universe of comps. These potential comps were generated and filtered using Comp Selection criteria described above herein, specifically: Property Type=Detached single-family house; Transaction Type=Standard arms-length transaction; Location Proximity=Within 0.5 mile radius; Time Proximity=180 days.

Next, a set of the most similar comps is selected for further processing from the plurality of potential comps by comparing the comps with the subject based on two measures of property similarity: the absolute percent differences of the Gross Living Area (GLA) and Sale Price using the modified sale price for comps and calculating an imputed sale price for the subject.

In a first sub-step, the percent difference of the absolute value of the difference of the GLA between each of the Comps 1-11 and the Woodbridge Property is calculated. The GLA values of each comp, as well as the absolute value of the GLA difference, is shown in Table 1 below.

TABLE 1
Listing of GLA and percent GLA difference for each of 11
potential comps (Comps 1-11) for the Woodbridge Property

| | GLA | Percent GLA |
|---|---|---|
| Comp | (square feet) | Difference |
| Comp 1 | 1,370 | 19.27% |
| Comp 2 | 943 | 17.29% |
| Comp 3 | 998 | 10.82% |
| Comp 4 | 1,120 | 1.25% |
| Comp 5 | 992 | 11.49% |
| Comp 6 | 1,409 | 21.50% |
| Comp 7 | 1,340 | 17.46% |
| Comp 8 | 1,296 | 14.66% |
| Comp 9 | 1,408 | 21.45% |
| Comp 10 | 1,402 | 21.11% |
| Comp 11 | 1,374 | 19.51% |

In a second sub-step, the subject imputed sale price is calculated as described herein above by (1) Determine the Absolute % Difference between the subject GLA and each of the potential comp GLAs (see Table 1);

(2) Find the five closest Comp Gross Living Areas (GLA) to the Subject GLA (Comps 2-5 and 8);

(3) Average the Comp Modified Sale Prices for those five closest comps, and assign that price as the Subject Imputed Sale Price ($317,420);

(4) Determine the Absolute % Difference between the Subject Imputed Sale Price and each of the potential comp Modified Sale Prices (see Table 2);

(5) Sum the Absolute Percent Differences in GLA and Sale Price into a Combined Percent Difference for each comp (see Table 3);

(6) Filter out any comps that are more than 20% of the Combined Percent Difference to prevent comparison of properties that are too dissimilar (delete Comps 1, 2, 6, 9-11, leaving the remaining Comps 3-5, 7-8 as the selected set of comps); and

(7) Select up to seven of the remaining most similar comps as the set of comps for further processing (only 5 comps remained from (6)).

The modified sale price for each of Comps 1-11 is then calculated. This modified sale price takes into account both the actual sale price of each comp, as well as the amount of any concessions. Specifically, for the case of this example and as shown below in Table 2, the modified sale price for each comp is the actual sale price minus any concession amount.

Then, the percent difference of the absolute value of the difference between a comp modified sale price and the subject imputed sale price is calculated, which is also shown in Table 2.

TABLE 2
Listing of sale price, concession, modified sale price,
and percent price difference for each of Comps 1-11

| | | | | Percent |
|---|---|---|---|---|
| | | | Modified Sale | Price |
| Comp | Sale Price | Concession | Price | Difference |
| Comp 1 | $359,900 | $0 | $359,900 | 11.80% |
| Comp 2 | $263,000 | $0 | $263,000 | 20.69% |
| Comp 3 | $306,100 | $0 | $306,100 | 3.70% |
| Comp 4 | $315,000 | $5,000 | $310,000 | 2.39% |
| Comp 5 | $315,000 | $4,500 | $310,500 | 2.23% |
| Comp 6 | $320,000 | $5,000 | $315,000 | 0.77% |
| Comp 7 | $325,000 | $4,875 | $320,125 | 0.84% |
| Comp 8 | $326,000 | $0 | $326,000 | 2.63% |
| Comp 9 | $335,100 | $10,053 | $325,047 | 2.35% |
| Comp 10 | $344,500 | $2,000 | $342,500 | 7.32% |
| Comp 11 | $349,000 | $0 | $349,000 | 9.05% |

To determine which of Comps 1-11 are the best comps for the Woodbridge Property, the percent GLA difference value (from Table 1) and the percent price difference value (from Table 2) is summed for each of these comps, thereby producing a combined percent difference. The result is shown in Table 3 below.

TABLE 3
Listing of percent GLA difference, percent price difference,
and combined percent difference for each of Comps 1-11

| | | | Combined |
|---|---|---|---|
| | Percent GLA | Percent Price | Percent |
| Comps | Difference | Difference | Difference |
| Comp 1 | 19.27% | 11.80% | 31.07% |
| Comp 2 | 17.29% | 20.69% | 37.98% |
| Comp 3 | 10.82% | 3.70% | 14.52% |
| Comp 4 | 1.25% | 2.39% | 3.64% |
| Comp 5 | 11.49% | 2.23% | 13.72% |
| Comp 6 | 21.50% | 0.77% | 22.27% |
| Comp 7 | 17.46% | 0.84% | 18.30% |
| Comp 8 | 14.66% | 2.63% | 17.29% |
| Comp 9 | 21.45% | 2.35% | 23.80% |
| Comp 10 | 21.11% | 7.32% | 28.43% |
| Comp 11 | 19.51% | 9.05% | 28.56% |

As can be seen, of the Comps 1-11, the comps with the lowest combined percent difference are Comps 3-5 and Comps 7-8. In this example, up to seven comps are chosen to comprise the set of comps. In addition, selected comps may be restricted to less than 20% of the Combined Percent Difference to prevent comparison of properties that are too dissimilar, as was done in this example.

These remaining most similar comps can then be used in order to provide a valuation for the Woodbridge Property, e.g., according to any of the methods and processes described above herein. A specific example for valuating the same subject property as described in this example will be provided below in Example 2.

### Example 2

This example utilizes the same subject property (the Woodbridge Property) as in Example 1 and relates to the scoring of various features and the adjustment values for these features. The relevant comps in this example are Comps 3-5 and Comps 7-8, as determined in Example 1.

For each of the above comps, both a raw feature score and a feature adjustment value is determined for each of a plurality of features. These features may include one or more of the non-limiting set of features mentioned in the present disclosure. Determination of the raw feature score, as well as calculation of the feature adjustment value, may likewise be achieved through any of the methods or processes mentioned above herein.

The table below lists a set of features for the Woodbridge Property that forms the basis for comparison with each of Comps 3-5 and 7-8. A skilled artisan will appreciate that the below list of features can be customized for any given subject property.

TABLE 4
Set of features and raw feature scores
for the Woodbridge Property

| Feature | Raw Feature Score |
|---|---|
| Concessions | $0 |
| GLA (square feet) | 1,106 |
| Bedrooms | 2 |
| Bathrooms | 3.5 |
| Finished basement living area | 432 |
| (square feet) | |
| Unfinished basement living area | 0 |
| (square feet) | |
| Basement features | 0 |
| Fireplace | 1 |
| Energy efficiency | 0.5 |
| Property style | 0 |
| Property age | 1994 |
| (year constructed) | |
| Lot size | 6% |
| (% acre) | |
| Site landscaping | 4 |
| Neighborhood | 4 |
| Days on market | 30 |
| Contract date adjustment | 0 |

The above set of features can be used as a basis for comparison between the Woodbridge Property and each of Comps 3-5 and 7-8. The tables below list the features for each of these comps, as well as the corresponding raw feature score and feature adjustment value for each feature.

TABLE 5
Set of features, feature scores, and feature
adjustment values for Comp 3

| | Raw Feature | Feature |
|---|---|---|
| Feature | Score | Adjustment Value |
| Concessions | $0 | $0 |
| GLA (square feet) | 998 | $4,652 |
| Bedrooms | 2 | $0 |
| Bathrooms | 3.5 | $0 |
| Finished basement living | 432 | $0 |
| area (square feet) | | |
| Unfinished basement | 0 | $0 |
| living area (square feet) | | |
| Basement features | 1.5 | −$1,837 |
| Fireplace | 1 | $0 |
| Energy efficiency | 0 | $918 |
| Property style | 1 | −$6,122 |
| Property age | 1998 | −$1,813 |
| (year constructed) | | |
| Lot size | 3% | $1,186 |
| (% acre) | | |
| Site landscaping | 4 | $0 |
| Neighborhood | 2.5 | −$2,755 |
| Days on market | 3 | $7,481 |
| Contract date adjustment | 1 | $3,061 |

Based on the above table, an adjusted sales price can be calculated for Comp 3 by summing all of the feature adjustment values to create a total adjustment value (in this case, $4,772) and adding that value to the modified sale price of Comp 3 (i.e., $306,100 as shown in Table 2). The adjusted sale price for Comp 3 is therefore $310,872.

TABLE 6
Set of features, feature scores, and feature
adjustment values for Comp 4

| | Raw Feature | Feature |
|---|---|---|
| Feature | Score | Adjustment Value |
| Concessions | $5,000 | −$5,000 |
| GLA (square feet) | 1,120 | −$616 |
| Bedrooms | 3 | −$2,205 |
| Bathrooms | 3.5 | $0 |
| Finished basement living | 494 | −$739 |
| area (square feet) | | |
| Unfinished basement | 0 | $0 |
| living area (square feet) | | |
| Basement features | 0 | $0 |
| Fireplace | 1 | $0 |
| Energy efficiency | 0 | $945 |
| Property style | 0 | $0 |
| Property age | 1983 | $4,649 |
| (year constructed) | | |
| Lot size | 4% | $813 |
| (% acre) | | |
| Site landscaping | 6 | $3,150 |
| Neighborhood | 2.5 | −$2,835 |
| Days on market | 15 | $4,119 |
| Contract date adjustment | 1 | $3,150 |

Based on the above table, an adjusted sales price can be calculated for Comp 4 by summing all of the feature adjustment values to create a total adjustment value (in this case, $5,431) and adding that value to the modified sale price of Comp 4 (i.e., $315,000 as shown in Table 2). The adjusted sale price for Comp 3 is therefore $320,431.

TABLE 7
Set of features, feature scores, and feature
adjustment values for Comp 5

| | Raw Feature | Feature |
|---|---|---|
| Feature | Score | Adjustment Value |
| Concessions | $4,500 | −$4,500 |
| GLA (square feet) | 992 | $5,056 |
| Bedrooms | 2 | $0 |
| Bathrooms | 3.5 | $0 |
| Finished basement living | 432 | $0 |
| area (square feet) | | |
| Unfinished basement | 0 | $0 |
| living area (square feet) | | |
| Basement features | 0 | $0 |
| Fireplace | 1 | $0 |
| Energy efficiency | 0 | $945 |
| Property style | 0 | $0 |
| Property age | 1998 | −$1,866 |
| (year constructed) | | |
| Lot size | 3% | $1,220 |
| (% acre) | | |
| Site landscaping | 5 | $1,575 |
| Neighborhood | 2.5 | −$2,835 |
| Days on market | 6 | $6,779 |
| Contract date adjustment | 0 | $0 |

Based on the above table, an adjusted sales price can be calculated for Comp 5 by summing all of the feature adjustment values to create a total adjustment value (in this case, $6,374) and adding that value to the modified sale price of Comp 5 (i.e., $315,000 as shown in Table 2). The adjusted sale price for Comp 5 is therefore $321,374.

TABLE 8
Set of features, feature scores, and feature
adjustment values for Comp 7

| | Raw Feature | Feature |
|---|---|---|
| Feature | Score | Adjustment Value |
| Concessions | $4,875 | −$4,875 |
| GLA (square feet) | 1,340 | −$10,478 |
| Bedrooms | 2 | $0 |
| Bathrooms | 3.5 | $0 |
| Finished basement living | 640 | −$2,534 |
| area (square feet) | | |
| Unfinished basement | 0 | $0 |
| living area (square feet) | | |
| Basement features | 0 | $0 |
| Fireplace | 1 | $0 |
| Energy efficiency | 0 | $975 |
| Property style | 1 | −$6,500 |
| Property age | 1994 | $0 |
| (year constructed) | | |
| Lot size | 3% | $1,259 |
| (% acre) | | |
| Site landscaping | 5 | $1,625 |
| Neighborhood | 2.5 | −$2,925 |
| Days on market | 5 | $7,309 |
| Contract date adjustment | 2 | $6,500 |

Based on the above table, an adjusted sales price can be calculated for Comp 7 by summing all of the feature adjustment values to create a total adjustment value (in this case, −$9,644) and adding that value to the modified sale price of Comp 7 (i.e., $325,000 as shown in Table 2). The adjusted sale price for Comp 7 is therefore $315,356.

TABLE 9
Set of features, feature scores, and feature
adjustment values for Comp 8

| | Raw Feature | Feature |
|---|---|---|
| Feature | Score | Adjustment Value |
| Concessions | $0 | $0 |
| GLA (square feet) | 1,296 | −$8,557 |
| Bedrooms | 3 | −$2,282 |
| Bathrooms | 3.5 | $0 |
| Finished basement living | 640 | −$2,542 |
| area (square feet) | | |
| Unfinished basement | 0 | $0 |
| living area (square feet) | | |
| Basement features | 1.5 | −$1,956 |
| Fireplace | 1 | $0 |
| Energy efficiency | 0.5 | $0 |
| Property style | 1 | −$6,520 |
| Property age | 1990 | $1,832 |
| (year constructed) | | |
| Lot size | 3% | $1,263 |
| (% acre) | | |
| Site landscaping | 5 | $1,630 |
| Neighborhood | 2.5 | −$2,934 |
| Days on market | 5 | $7,331 |
| Contract date adjustment | 3 | $9,780 |

Based on the above table, an adjusted sales price can be calculated for Comp 8 by summing all of the feature adjustment values to create a total adjustment value (in this case, −$2,954) and adding that value to the modified sale price of Comp 8 (i.e., $326,000 as shown in Table 2). The adjusted sale price for Comp 8 is therefore $323,046.

Purely as non-limiting examples, four options can then be used to calculate the final valuation of the subject property, namely (1) a default valuation based on relative weighting of total net feature adjustments, (2) a valuation based on relative weighting of total absolute feature adjustments, (3) a valuation based on the median Adjusted Sale Price, and/or (4) a valuation based on the average (or mean) Adjusted Sale Price.

The total net feature adjustment values for each of Comps 3-5 and 7-8 are:

Comp 3=$4,772;

Comp 4=$5,431;

Comp 5=$6,374;

Comp 7=−$9,644;

Comp 8=−$2,954.

The adjusted sale prices for each of Comps 3-5 and 7-8 are:

Comp 3=$310,872;

Comp 4=$320,431;

Comp 5=$321,374;

Comp 7=$315,356;

Comp 8=$323,046.

Results for the 4 aforementioned options for calculating the final subject valuation are:
(1) Relative weighting of total net feature adjustments=$318,993;
(2) Relative weighting of total absolute feature adjustments=$318,277;
(3) Median Adjusted Sale Price=$320,431;
(4) Average (or mean) Adjusted Sale Price=$318,216;

In some implementations, option (1) is the default and preferred one.

This valuation is an accurate representation of the sale price of the Woodbridge Property, as evidenced by the fact that the estimated sale price of the subject property is extremely close by all 4 valuation options, and that the average difference from comp tests between estimated values and actual sale prices was 0.25%.

### Example 3

This example describes a method for valuating fine art, specifically, the oil painting “Land's End, Cornwall 1884” by William Trost Richards (“Richards”), an artist of the Hudson Valley school of American landscape artists.

The first step of the method, as is the case with embodiments of the present disclosure relating to valuating real estate, is to select relevant comps for the painting. Rather than select comps based on criteria related to real estate, such as, for example, location proximity, property type, time proximity, and transaction type, the following criteria were used: (1) artist, (2) medium, (3) subject matter, (4) scene detail, (5) location, and (6) size. It should be appreciated, however, that comp selection may be based on one or more criteria described above herein with respect to real estate valuation, including, for example, sale price and overall area). Additionally, some of the comp selection criteria may also serve as features for comparison and valuation.

For the “Land's End, Cornwall 1884” painting, the details of the above six criteria are as follows:

(1) Artist=all paintings by Richards;

(2) Medium=all oil paintings;

(3) Subject matter=paintings with coastal scenes;

(4) Scene detail=paintings depicting rocky environments with cliffs;

(5) Location=paintings with similar or nearby locations as that depicted (i.e., Land's End in Cornwall);

(6) Size=paintings with a size similar to 25 inches×35 inches.

It should be appreciated that other different criteria may be used for different types of fine art and/or different types of personal property, such as, for example, vehicles.

An online database of painting sales from auction houses was used from which to draw potential comps. The database, as well as other similar databases in the field, contains hundreds of thousands of transactions for tens of thousands of artists. Each transaction listing contains a set of data, including, for example, an image of the work sold, sales information, and the like.

Application of the first three criteria listed above (i.e., artist, medium, and subject matter) yielded 13 potential comps from the database. Further application of the final three listed criteria (i.e., scene detail, location, and size) restricted the number of potential comps to 7. These comps were taken as the final comps for the “Land's End, Cornwall 1884” painting.

Specifically, the titles of these 7 comp paintings are: (1) “Sunset along the Coast of Cornwall, 1882,” (2) “Shores of Bude Cornwall,” (3) “Cliffs and Waves,” (4) “Rocky Coast,” (5) “Yellow Carn of Cornwall,” (6) “Rock Bound Coast,” and (7) “Tintagel Coast.”

Once the above 7 comps were selected, a plurality of features for each comp was chosen on which to base evaluation and pricing of both the comps and the “Land's End, Cornwall 1884” painting. The features used were as follows:

(1) Artist name;

(2) Medium;

(3) Subject matter;

(4) Painting title;

(5) Hammer price (i.e., the amount of the winning bid);

(6) Auction estimate (i.e., an adjustment comparing expert estimates on the sales price of the work with the actual sales price, since emotions and preferences can sway bidding);

(7) Height;

(8) Width;

(9) Painting size (i.e., overall area, which is the height multiplied by the width);

(10) Sales trend (i.e., adjustment of sales prices over time, since the average price has increased roughly 25% over the past 25 years);

(11) Quality rating;

(12) Condition rating;

(13) Auction house;

(14) Auction house rating (i.e., a rating to reflect the prominence and prestige of the auction house where the work is being sold);

(15) Additional features (i.e., any additional features that may be relevant to valuations, including, for example, the period or year the work was painted, the quality of the provenance, whether the work is signed, the sales history of the work, and the like).

Next, a numeric feature score was assigned to each of the aforementioned 15 features, similar to step 106 of FIG. 1 as described above herein. Certain features, such as, for example, the auction house rating, had numeric rating scores assigned, similar to features with Likert scale ratings, as described above herein. Other features, such as, for example, the hammer price, had numeric values that were extracted from sales data and/or from the online database of painting sales already described herein.

Once numeric feature scores were assigned, each feature score was adjusted, generating Feature Adjustment Values, similar to step 108 of FIG. 1 described above herein. Then, the “Land's End, Cornwall 1884” painting was valuated based on the Feature Adjustment Values for each comp, similar to step 110 of FIG. 1 described above herein. In other words, Total Feature Adjustment values for each comp were calculated, and then an Adjusted Sale Price was produced. The resulting valuation of the painting was $51,684.

Any process descriptions, elements, or units in the diagrams described herein and/or depicted in the attached figures should be understood as potentially representing units, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

The foregoing description details certain embodiments of systems and methods for valuating property. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

The invention is not limited to the particular embodiments illustrated in the drawings and described above in detail. Those skilled in the art will recognize that other arrangements could be devised. The invention encompasses every possible combination of the various features of each embodiment or implementation disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims.

I claim:

1. An automated method for valuating a subject property, the method comprising:
accessing comparison property data from a comparison property database, wherein the comparison property data includes comparison property identifiers for a plurality of comparison properties and a plurality of features, and each comparison property identifier corresponds to at least one feature from among the plurality of features;
selecting a set of comparison properties from the plurality of comparison properties by further selecting a plurality of search and similarity parameters, wherein the set of comparison properties comprise comparison properties most similar to the subject property; and
executing a set of computer-executable instructions stored on one or more non-transitory computer readable media, wherein when executed by at least one processor, the computer-executable instructions carry out the following steps:
applying one of a plurality of feature scoring algorithms to feature data inputs depending on feature type to calculate a numeric feature score for each of the plurality of features for both the set of comparison properties and the subject property,
adjusting, for each comparison property in the set of comparison properties, each numeric feature score based on a difference between the numeric feature scores for the subject property and the comparison property,
calculating a feature adjustment value for each of the plurality of features by multiplying a feature adjustment score, a feature adjustment fraction, and a comp modified sale price together for each comparable property in the set of comparison properties,
totaling the feature adjustment values and the modified sale price for each comparison property in the set of comparison properties, thereby yielding an adjusted sale price for each comparison property, and
applying a weighting formula to each comparison property in the set of comparison properties that reflects degree of similarity to the subject property based on an amount of total net adjustments, thereby reaching a final valuation of the subject property.

2. The automated method of claim 1, wherein, in order to select the set of comparison properties, a numeric similarity score for each comparison property in the set of comparison properties is calculated, wherein the numeric similarity score is indicative of a degree of similarity and relevance of the corresponding comparison property to the subject property based on one or more characteristics.

3. The automated method of claim 1, wherein, in order to calculate similarity scores to select the set of comparison properties, the plurality of search and similarity parameters is selected from the group consisting of: property type, transaction type, location proximity, time proximity, gross living area (GLA), modified sale price, and combinations thereof.

4. The automated method of claim 1, wherein the plurality of features is selected from the group consisting of: sale price, concessions, modified sale price, number of bedrooms, number of bathrooms, flooring, fireplace, nearby amenities, contract date adjustment, current market conditions, basement features, energy, property style, remodeling, exterior finish, exterior features, parking, street traffic, gross living area (GLA), basement finished living area, basement unfinished living area, lot size, property age, days on market (DOM), quality of construction, condition, how well property shows, site landscaping, neighborhood, school quality, remarks, and combinations thereof.

5. The automated method of claim 1, wherein the calculation of the numeric feature score further comprises:
applying either an exponential decay formula or, alternatively, a polynomial regression formula to calculate value for at least some features in the plurality of features.

6. The automated method of claim 1, wherein the calculation of the numeric feature score further comprises:
applying Likert scale measurements to grade subjective judgments as numeric rankings for at least some features in the plurality of features.

7. The automated method of claim 1, wherein the calculation of the numeric feature score further comprises:
applying text analysis and/or text mining to text-containing data fields in a plurality of listings in a multiple listing service, wherein the multiple listing service is a service comprising a database of properties, wherein the database comprises the plurality of listings, and wherein each of the listings in the plurality of listings represents a different comparison property from among the set of comparison properties.

8. The automated method of claim 1, wherein the calculation of the numeric feature score further comprises:
applying nominal feature scores to a plurality of aspects and/or attributes within at least one feature in the plurality of features.

9. The automated method of claim 1, wherein the calculation of the numeric feature score further comprises:
converting a categorical symbolic data input into a nominal feature score reflective of general market desirability for at least one feature in the plurality of features.

10. The automated method of claim 1, further comprising:
utilizing sales data to adjust for sale price differences over time between a contract date of at least one of the comparison properties in the set of comparison properties and current analysis date.

11. The automated method of claim 1, further comprising:
adjusting the valuation of a comparable property based on current market conditions by considering factors selected from the group consisting of: average DOM, average listing price vs. contract price, mortgage rates, sale listings, recent sales, short sales of other properties near the subject property, percent rentals, and combinations thereof.

12. The automated method of claim 1, further comprising:
storing at least one of the plurality of features, the numeric feature scores, and the feature adjustment values.

13. The automated method of claim 1, further comprising:
employing data quality and data cleaning techniques to identify and resolve missing or out-of-range values.

14. A system for valuating a subject property, the system comprising:
at least one computer comprising at least one processor operatively connected to at least one non-transitory, computer readable medium, the at least one non-transitory computer readable medium having computer-executable instructions stored thereon, wherein when executed by the at least one processor the computer executable instructions carry out a set of steps defining
an automated valuation model for appraising and valuing a subject property, the steps in the set of steps comprising:
defining a set of features for the subject property, the set of features comprising a plurality of features of the subject property,
for each comparison property in a selected set of comparison properties, assigning a numerical feature score to each feature in the set of features,
for each comparison property in the selected set of comparison properties, adjusting each numeric feature score to produce a feature adjustment value for the each feature in the set of features, and
valuating the subject property based on the feature adjustment values of the comparison properties in the selected set of comparison properties.

15. The system of claim 14, wherein the steps in the set of steps further comprise:
calculating a similarity score for each comparison property in a plurality of potential comparison properties, wherein the score is indicative of a degree of similarity of the corresponding comparison property and the subject property based on one or more characteristics, and
applying the similarity scores to select the set of comparison properties from the plurality of potential comparison properties.

16. The system of claim 14, wherein the steps in the set of steps further comprise:
applying one or more exponential decay formulas.

17. The system of claim 14, wherein the steps in the set of steps further comprise:
applying Likert scale numeric ranking measurements to grade subjective judgments for at least some features in the set of features.

18. The system of claim 14, wherein the steps in the set of steps further comprise:
applying text analysis to a plurality of listings in a multiple listing service, wherein the multiple listing service is a service comprising a database of properties, wherein the database comprises the plurality of listings, and wherein each of the listings in the plurality of listings represents a different property.

19. The system of claim 14, wherein the steps in the set of steps further comprise:
applying nominal value scores to a plurality of attributes within a feature in the set of features.

20. The system of claim 14, wherein the steps in the set of steps further comprise:
utilizing sales data to adjust for sale price differences over time between sales of the comparable properties and current market conditions.

21. The system of claim 14, wherein the steps in the set of steps further comprise:
adjusting valuation of the subject property based on current market conditions by considering factors selected from the group consisting of: average days on market; average listing price vs. contract price; recent sale price trends of other properties near the subject property; seasonality; demand; inventory; regional/local average housing sale prices; percent of real estate owned by banks; percent of short sales; and percent of rentals.

22. The system of claim 14, further comprising:
a dictionary comprising a plurality of real-estate terms used in selling property; and
a term matrix capable of isolating commonly-used terms in the plurality of real-estate terms.

23. A system for valuating a subject property, the system comprising at least one computer comprising at least one processor, where in the at least one processor is operatively connected to at least one non-transitory, computer readable medium having a plurality of computer executable programs stored thereon, the plurality computer executable programs comprising:
a feature definer, wherein when executed by the at least one processor, the feature definer defines a set of features for a subject property, the set of features comprising a plurality of features of the subject property,
a score assigner, wherein when executed by the at least one processor, for each comparison property in a selected set of comparison properties, the score assigner assigns a numerical feature score to each feature in the set of features,
a feature adjuster, wherein when executed by the at least one processor, for each comparison property in a selected set of comparison properties, the feature adjuster adjusts each feature score to produce a feature adjustment value for the each feature in the set of features, and
a valuation calculator, wherein when executed by the at least one processor, for each comparison property in a selected set of comparison properties, the valuation calculator valuates the subject property based on the feature adjustment values.

24. The system of claim 23, wherein one or more of the plurality of computer executable programs defines an automated valuation model for appraising and valuing the subject property.

25. A system for predicting value of one or more items, the system comprising at least one computer comprising at least one processor, where in the at least one processor is operatively connected to at least one non-transitory, computer readable medium having a plurality of computer executable programs stored thereon, the plurality computer executable programs comprising:
a data compiler, wherein when executed by the at least one processor, the data compiler compiles data from one or more past sales, and the one or more past sales are of items belong to a same category as that of one or more items to be valuated,
a data analyzer, wherein when executed by the at least one processor, the data analyzer analyzes the one or more past sales, and
a prediction engine, wherein when executed by the at least one processor, the prediction engine predicts a value of the one or more items to be valuated based on the analyzed data from the one or more past sales.
